(19) United States
(12) Patent Application Publication
(10) Pub. No.: US 2023/0008647 A1
(43) Pub. Date: Jan. 12, 2023

(54) CONNECTION ESTABLISHMENT METHOD, COMMUNICATION APPARATUS, AND SYSTEM

(71) Applicant: HUAWEI TECHNOLOGIES CO., LTD., Shenzhen (CN)

(72) Inventors: Qi YAO, Beijing (CN); Zaifeng ZONG, Nanjing (CN)

(21) Appl. No.: 17/951,164

(22) Filed: Sep. 23, 2022

Related U.S. Application Data
(63) Continuation of application No. PCT/CN2021/082337, filed on Mar. 23, 2021.

(30) Foreign Application Priority Data
Mar. 25, 2020 (CN) 202010220128.4

(51) Int. Cl. H04W 48/18; H04W 76/10; H04W 4/029

(52) U.S. Cl. CPC H04W 48/18; H04W 4/029; H04W 76/10

(57) ABSTRACT

A connection establishment method, a communication apparatus, and a system which are applied to a terminal device connected to an edge network. The method includes a core network element sending first information to at least one control network element, where the first information indicates that an edge network corresponding to a user plane network element serving the terminal device changes. The at least one control network element sends connection information of a first network element to the terminal device based on the first information, where the first network element is a network element in a first edge network corresponding to the user plane network element. After receiving the connection information of the first network element, and the connection information is used for the terminal device to connect to the first network element.

### CROSS-REFERENCE TO RELATED APPLICATIONS

This application is a continuation of International Application No. PCT/CN2021/082337, filed on Mar. 23, 2021, which claims priority to Chinese Pat. Application No.202010220128.4, filed on Mar. 25, 2020. The disclosures of the aforementioned applications are hereby incorporated in entirety by reference.

### BACKGROUND

In a 5th generation mobile communication system (5th generation wireless system, 5G), a gateway is split into a control plane (control plane) and a user plane (user plane). The user plane and the control plane may separately support independent scaling, to improve elasticity and flexibility of the communication system. In a logical set of the control plane, the user plane can be deployed to be closer to user, to reduce a transmission delay.

After accessing a network, user equipment (user equipment, UE) in the communication system establishes a protocol data unit (protocol data unit, PDU) session, accesses an external data network (data network, DN) by using the PDU session, and interacts with an application network element deployed in the data network. Since data networks accessed by a user are different, a network element that implements a session management function (session management function, SMF) may choose to access a network element that implements a user plane function (user plane function, UPF) in a data network, and access an application network element via the UPF. The UPF network element is used as an uplink classifier (uplink classifier, ULCL), and the ULCL may steer some traffic to a local data network for local routing.

To meet the call of some low-delay and high-bandwidth applications, application network elements can be deployed at the edge of the data network, so that the application network elements can be closer to users, further reducing an end-to-end service delay and improving a network bandwidth. For example, the data network at the edge is an environment (edge hosting environment, EHE) or a data center (data center, DC) in which an edge application can be deployed. The EHE is further referred to as an edge data network (edge data network, EDN). A system architecture of the EHE includes an edge enabler server (edge enabler server, EES). A system architecture of the DC includes a mobile edge computing platform (mobile edge computing platform, MEP).

Currently, the UE can obtain edge data network information based on preconfigured information, and the UE can attempt to connect to the edge of a preconfigured data network. This reduces a success rate of establishing a connection by the UE with the edge of the data network.

### SUMMARY

Embodiments provide a connection establishment method, a communication apparatus, and a system, to improve a success rate of establishing a connection by a terminal device with an edge network.

To resolve the foregoing technical problem, embodiments provide the following technical solutions.

According to a first aspect, an embodiment provides a connection establishment method. The method includes a control network element that receives first information from a core network element, where the first information indicates that an edge network corresponding to a user plane network element serving a terminal device changes. The control network element sends connection information of a first network element to the terminal device based on the first information, where the first network element is a network element in a first edge network corresponding to the user plane network element, and the connection information is used for the terminal device to connect to the first network element. In some embodiments, the terminal device obtains, from the control network element, the connection information of the first network element, and establish a connection between the terminal device and the first network element. The edge network does not need to be preconfigured for the terminal device provided in some embodiments. The terminal device establishes the connection between the terminal device and the first network element based on the connection information of the first network element sent by the control network element. In this case, connection establishment is dynamically triggered based on a change of the edge network corresponding to the user plane network element, and a success rate of establishing a connection by the terminal device with the edge network is improved.

In some embodiments, before that a control network element receives first information from a core network element, the method further includes: The control network element sends subscription request information to the core network element, where the subscription request information requests the core network element to send the first information in response to detecting that a location of the terminal device changes, the subscription request information requests the core network element to send the first information in response to detecting that the edge network corresponding to the user plane network element changes, or the subscription request information requests the core network element to send the first information in response to detecting that a user plane management event occurs. In this solution, the control network element further sends the subscription request information to the core network element, and the core network element receives the subscription request information sent by the at least one control network element. The core network element detects, based on the subscription request information, whether the location of the terminal device changes, detects whether the edge network corresponding to the user plane network element changes, or detects whether the user plane management event occurs. The core network element sends the first information in response to detecting that the location of the terminal device changes, send the first information in response to detecting that the edge network corresponding to the user plane network element changes, or send the first information in response to detecting that the user plane management event occurs. Therefore, the core network element sends the foregoing first information to the control network element by using the subscription request information sent by the control network element to the core network element, and the control network element sends the connection information of the first network element based on the first information, so that the terminal device is connected to the first edge network by using the connection information.

In some embodiments, the first information further includes the location of the terminal device, and the method further includes: The control network element determines the first edge network or determines the first network element based on at least the location of the terminal device. In this solution, service range information of a network element in the edge network is configured on the control network element. In response to the first information including the location of the terminal device, the control network element determines that a network element whose service range includes the location of the terminal device is the first network element. The control network element determines the first edge network or determines the first network element based on at least the location of the terminal device. In other words, the control network element determines, based on the location of the terminal device, the first edge network in a plurality of edge networks corresponding to a plurality of user plane network elements serving the terminal device. Alternatively, the control network element determines, based on the location of the terminal device, the first network element in network elements in a plurality of edge networks.

In some embodiments, the control network element is a central control network element, and a plurality of edge networks correspond to the user plane network element; and that the control network element sends connection information of a first network element to the terminal device based on the first information includes: The central control network element selects at least one edge network from the plurality of edge networks as the first edge network, or the central control network element selects at least one network element from network elements included in the plurality of edge networks as the first network element; and the central control network element sends the connection information to the terminal device. In some embodiments, the central control network element selects the first edge network from the plurality of edge networks, or selects the first network element from the network elements included in the plurality of edge networks. In this case, the central control network element sends the connection information of the selected first network element to the terminal device, so that the terminal device establishes a connection with the first network element selected by the central control network element from the first edge network, thereby improving a success rate of establishing a connection by the terminal device with the edge network.

In some embodiments, the method further includes: The central control network element receives a plurality of pieces of delay information from the core network element, where each piece of delay information includes a transmission delay between the terminal device and one user plane network element. That the central control network element selects at least one edge network from the plurality of edge networks as the first edge network includes: The central control network element selects at least one edge network from the plurality of edge networks as the first edge network based on at least the plurality of pieces of delay information. That the central control network element selects at least one network element from network elements included in the plurality of edge networks as the first network element includes: The central control network element selects at least one network element from the network elements included in the plurality of edge networks as the first network element based on at least the plurality of pieces of delay information. In some embodiments, the central control network element selects the first edge network from the plurality of edge networks based on at least the delay information, or selects, based on at least the delay information, the first network element from the network elements included in the plurality of edge networks. In this case, the central control network element sends the connection information of the selected first network element to the terminal device, so that the terminal device establishes a connection with the first network element selected by the central control network element from the first edge network, thereby improving a success rate of establishing a connection by the terminal device with the edge network.

In some embodiments, the control network element is a central control network element, one edge network corresponds to the user plane network element, and the one edge network corresponding to the user plane network element is the first edge network. That the control network element sends connection information of a first network element to the terminal device based on the first information includes: The central control network element selects at least one network element from network elements in the first edge network as the first network element; and the central control network element sends the connection information to the terminal device. In some embodiments, the central control network element selects the first network element from the network elements included in the first edge network. In this case, the central control network element sends the connection information of the selected first network element to the terminal device, so that the terminal device establishes a connection with the first network element selected by the central control network element, thereby improving a success rate of establishing a connection by the terminal device with the edge network.

In some embodiments, that the control network element sends connection information of a first network element to the terminal device includes: The control network element sends the connection information to the terminal device via the core network element. In some embodiments, the terminal device receives the connection information of the first network element via the core network element, so that the terminal device no longer uses a preconfigured manner to establish the connection, and the connection information of the first network element is generated based on the location of the terminal device, thereby improving a success rate of establishing a connection by the terminal device with the first network element in the first edge network.

In some embodiments, the first network element includes at least one of the following: a first control network element in the first edge network and a first application network element in the first edge network.

In some embodiments, the method further includes after the terminal device establishes a connection with the first control network element, the first control network element sends application information of the first application network element to the terminal device. In some embodiments, the terminal device receives the application information sent by the first control network element in the first edge network, the terminal device parses the application information to determine the first application network element included in the first edge network to which the terminal device establishes a connection, and the terminal device initiates an access request to the first application network element. In this way, the terminal device completes an entire process of application discovery.

According to a second aspect, an embodiment further provides a connection establishment method. The method includes a core network element sends first information to at least one control network element, where the first information indicates that an edge network corresponding to a user plane network element serving a terminal device changes. The core network element receives connection information of a first network element sent by the at least one control network element, where the first network element is a network element in a first edge network corresponding to the user plane network element, and the connection information is used for the terminal device to connect to the first network element. The core network element sends the connection information of the first network element to the terminal device. In some embodiments, the terminal device obtains, from the control network element, the connection information of the first network element, and establish a connection between the terminal device and the first network element. The edge network does not need to be preconfigured for the terminal device provided in some embodiments. The terminal device establishes the connection between the terminal device and the first network element based on the connection information of the first network element sent by the control network element. In this case, connection establishment is dynamically triggered based on a change of the edge network corresponding to the user plane network element, and a success rate of establishing a connection by the terminal device with the edge network is improved.

In some embodiments, before that a core network element sends first information to at least one control network element, the method further includes: The core network element receives location request information sent by the at least one control network element, where the location request information requests the core network element to send the first information; or the core network element receives subscription request information sent by the control network element, where the subscription request information requests the core network element to send the first information in response to detecting that a location of the terminal device changes, the subscription request information requests the core network element to send the first information in response to detecting that the edge network corresponding to the user plane network element changes, or the subscription request information requests the core network element to send the first information in response to detecting that a user plane management event occurs. In this solution, the control network element further sends the subscription request information to the core network element, and the core network element receives the subscription request information sent by the at least one control network element. The core network element detects, based on the subscription request information, whether the location of the terminal device changes, detects whether the edge network corresponding to the user plane network element changes, or detects whether the user plane management event occurs. The core network element sends the first information in response to detecting that the location of the terminal device changes, send the first information in response to detecting that the edge network corresponding to the user plane network element changes, or send the first information in response to detecting that the user plane management event occurs. Therefore, the core network element sends the foregoing first information to the control network element by using the subscription request information sent by the control network element to the core network element, and the control network element sends the connection information of the first network element based on the first information, so that the terminal device is connected to the first edge network by using the connection information.

In some embodiments, the first information further includes the location of the terminal device, and the location of the terminal device is used for the at least one control network element to determine the first edge network or determine the first network element. In this solution, service range information of a network element in the edge network is configured on the control network element. In response to the first information including the location of the terminal device, the control network element determines that a network element whose service range includes the location of the terminal device is the first network element. The control network element determines the first edge network or determines the first network element based on at least the location of the terminal device. In other words, the control network element determines, based on the location of the terminal device, the first edge network in a plurality of edge networks corresponding to a plurality of user plane network elements serving the terminal device. Alternatively, the control network element determines, based on the location of the terminal device, the first network element in network elements in a plurality of edge networks.

In some embodiments, the at least one control network element includes a central control network element; a plurality of edge networks correspond to the user plane network element; the first edge network is at least one edge network selected by the central control network element from the plurality of edge networks; or the first network element is at least one network element selected by the central control network element from network elements included in the plurality of edge networks. In some embodiments, the central control network element selects the first edge network from the plurality of edge networks, or selects the first network element from the network elements included in the plurality of edge networks. In this case, the central control network element sends the connection information of the selected first network element to the terminal device, so that the terminal device establishes a connection with the first network element selected by the central control network element from the first edge network, thereby improving a success rate of establishing a connection by the terminal device with the edge network.

In some embodiments, the method further includes: The core network element receives delay information from a plurality of user plane network elements, where each piece of delay information includes a transmission delay between the terminal device and one user plane network element. The core network element sends, to the central control network element, the delay information from the plurality of user plane network elements, where the delay information is used for the central control network element to: select at least one edge network from the plurality of edge networks as the first edge network, or select at least one network element from network elements included in the plurality of edge networks as the first network element. In some embodiments, the central control network element selects the first edge network from the plurality of edge networks based on at least the delay information, or selects, based on at least the delay information, the first network element from the network elements included in the plurality of edge networks. In this case, the central control network element sends the connection information of the selected first network element to the terminal device, so that the terminal device establishes a connection with the first network element selected by the central control network element from the first edge network, thereby improving a success rate of establishing a connection by the terminal device with the edge network.

In some embodiments, the method further includes: The core network element receives indication information sent by the at least one control network element, where the indication information indicates the core network element to send the connection information to the terminal device. In some embodiments, the at least one control network element sends the connection information of the first network element to the terminal device via the core network element. For example, the control network element sends the connection information of the first network element to the core network element, where the connection information of the first network element further includes indication information, and the core network element sends the connection information of the first network element to the terminal device based on the indication information. In some embodiments, the indication information enables the core network element to send the connection information of the first network element to the terminal device, so that the terminal device receives the connection information of the first network element via the core network element.

According to a third aspect, an embodiment further provides a connection establishment method. The method includes a terminal device receives, from a control network element, connection information of a first network element, where the first network element is a network element in a first edge network corresponding to a user plane network element serving the terminal device. The terminal device establishes a connection between the terminal device and the first network element based on the connection information. In some embodiments, the terminal device obtains, from the control network element, the connection information of the first network element, and establish a connection between the terminal device and the first network element. The edge network does not need to be preconfigured for the terminal device provided in some embodiments. The terminal device establishes the connection between the terminal device and the first network element based on the connection information of the first network element sent by the control network element. In this case, connection establishment is dynamically triggered based on a change of the edge network corresponding to the user plane network element, and a success rate of establishing a connection by the terminal device with the edge network is improved.

In some embodiments, a plurality of edge networks correspond to the user plane network element. That the terminal device establishes a connection between the terminal device and the first network element based on the connection information includes: The terminal device selects at least one edge network from the plurality of edge networks as the first edge network, or the terminal device selects at least one network element from network elements included in the plurality of edge networks as the first network element. The terminal device establishes a connection between the terminal device and the first network element based on the connection information.

In some embodiments, the method further includes: The terminal device receives delay information of a plurality of user plane network elements sent by the core network element, where each piece of delay information includes a transmission delay between the terminal device and one user plane network element. That the terminal device selects at least one edge network from the plurality of edge networks as the first edge network includes: The terminal device selects at least one edge network from the plurality of edge networks as the first edge network based on at least the delay information. That the terminal device selects at least one network element from network elements included in the plurality of edge networks as the first network element includes: The terminal device selects at least one network element from the network elements included in the plurality of edge networks as the first network element based on at least the delay information.

In some embodiments, the first network element includes at least one of the following: a first control network element in the first edge network and a first application network element in the first edge network.

In some embodiments, the method further includes: After the terminal device establishes a connection with the first control network element, the terminal device receives application information that corresponds to the first application network element and that is sent by the first control network element; and the terminal device sends an access request to the first application network element. In some embodiments, the terminal device receives the application information sent by the first control network element in the first edge network, the terminal device parses the application information to determine the first application network element included in the first edge network to which the terminal device establishes a connection, and the terminal device initiates an access request to the first application network element. In this way, the terminal device completes an entire process of application discovery.

According to a fourth aspect, an embodiment further provides a connection establishment method. The method includes a core network element sends first information to at least one control network element, where the first information indicates that an edge network corresponding to a user plane network element serving a terminal device changes. The at least one control network element sends connection information of a first network element to the terminal device based on the first information, where the first network element is a network element in a first edge network corresponding to the user plane network element. After receiving the connection information of the first network element, the terminal device establishes a connection between the terminal device and the first network element based on the connection information. In some embodiments, the terminal device obtains, from the control network element, the connection information of the first network element, and establish a connection between the terminal device and the first network element. The edge network does not need to be preconfigured for the terminal device provided in some embodiments. The terminal device establishes the connection between the terminal device and the first network element based on the connection information of the first network element sent by the control network element. In this case, connection establishment is dynamically triggered based on a change of the edge network corresponding to the user plane network element, and a success rate of establishing a connection by the terminal device with the edge network is improved.

In some embodiments, before that a core network element sends first information to at least one control network element, the method further includes: The at least one control network element sends subscription request information to the core network element, where the subscription request information requests the core network element to send the first information in response to detecting that a location of the terminal device changes, the subscription request information requests the core network element to send the first information in response to detecting that the edge network corresponding to the user plane network element changes, or the subscription request information requests the core network element to send the first information in response to detecting that a user plane management event occurs. In this solution, the control network element further sends the subscription request information to the core network element, and the core network element receives the subscription request information sent by the at least one control network element. The core network element detects, based on the subscription request information, whether the location of the terminal device changes, detects whether the edge network corresponding to the user plane network element changes, or detects whether the user plane management event occurs. The core network element sends the first information in response to detecting that the location of the terminal device changes, send the first information in response to detecting that the edge network corresponding to the user plane network element changes, or send the first information in response to detecting that the user plane management event occurs. Therefore, the core network element sends the foregoing first information to the control network element by using the subscription request information sent by the control network element to the core network element, and the control network element sends the connection information of the first network element based on the first information, so that the terminal device is connected to the first edge network by using the connection information.

In some embodiments, the first information further includes the location of the terminal device. The method further includes: The at least one control network element determines the first edge network or determines the first network element based on at least the location of the terminal device. In this solution, service range information of a network element in the edge network is configured on the control network element. In response to the first information including the location of the terminal device, the control network element determines that a network element whose service range includes the location of the terminal device is the first network element. The control network element determines the first edge network or determines the first network element based on at least the location of the terminal device. In other words, the control network element determines, based on the location of the terminal device, the first edge network in a plurality of edge networks corresponding to a plurality of user plane network elements serving the terminal device. Alternatively, the control network element determines, based on the location of the terminal device, the first network element in network elements in a plurality of edge networks.

In some embodiments, the at least one control network element is a central control network element, and a plurality of edge networks correspond to the user plane network element. That the at least one control network element sends connection information of a first network element to the terminal device based on the first information includes: The central control network element selects at least one edge network from the plurality of edge networks as the first edge network, or the central control network element selects at least one network element from network elements included in the plurality of edge networks as the first network element; and the central control network element sends the connection information to the terminal device. In some embodiments, the central control network element selects the first edge network from the plurality of edge networks, or selects the first network element from the network elements included in the plurality of edge networks. In this case, the central control network element sends the connection information of the selected first network element to the terminal device, so that the terminal device establishes a connection with the first network element selected by the central control network element from the first edge network, thereby improving a success rate of establishing a connection by the terminal device with the edge network.

In some embodiments, the method further includes: The central control network element receives a plurality of pieces of delay information from the core network element, where each piece of delay information includes a transmission delay between the terminal device and one user plane network element. That the central control network element selects at least one edge network from the plurality of edge networks as the first edge network includes: The central control network element selects at least one edge network from the plurality of edge networks as the first edge network based on at least the plurality of pieces of delay information. That the central control network element selects at least one network element from network elements included in the plurality of edge networks as the first network element includes: The central control network element selects at least one network element from the network elements included in the plurality of edge networks as the first network element based on at least the plurality of pieces of delay information. In some embodiments, the central control network element selects the first edge network from the plurality of edge networks based on at least the delay information, or selects, based on at least the delay information, the first network element from the network elements included in the plurality of edge networks. In this case, the central control network element sends the connection information of the selected first network element to the terminal device, so that the terminal device establishes a connection with the first network element selected by the central control network element from the first edge network, thereby improving a success rate of establishing a connection by the terminal device with the edge network.

In some embodiments, the at least one control network element is a central control network element, one edge network corresponds to the user plane network element, and the one edge network corresponding to the user plane network element is the first edge network. That the at least one control network element sends connection information of a first network element to the terminal device based on the first information includes: The central control network element selects at least one network element from network elements in the first edge network as the first network element; and the central control network element sends the connection information to the terminal device. In some embodiments, the central control network element selects the first network element from the network elements included in the first edge network. In this case, the central control network element sends the connection information of the selected first network element to the terminal device, so that the terminal device establishes a connection with the first network element selected by the central control network element, thereby improving a success rate of establishing a connection by the terminal device with the edge network.

In some embodiments, that the at least one control network element sends connection information of a first network element to the terminal device includes: The at least one control network element sends the connection information to the terminal device via the core network element. In some embodiments, the terminal device receives the connection information of the first network element via the core network element, so that the terminal device no longer uses a preconfigured manner to establish the connection, and the connection information of the first network element is generated based on the location of the terminal device, thereby improving a success rate of establishing a connection by the terminal device with the first network element in the first edge network.

In some embodiments, the first network element includes at least one of the following: a first control network element in the first edge network and a first application network element in the first edge network.

In some embodiments, the method further includes after the terminal device establishes a connection with the first control network element, the at least one control network element sends application information of the first application network element to the terminal device. In some embodiments, the terminal device receives the application information sent by the first control network element in the first edge network, the terminal device parses the application information to determine the first application network element included in the first edge network to which the terminal device establishes a connection, and the terminal device initiates an access request to the first application network element. In this way, the terminal device completes an entire process of application discovery.

According to a fifth aspect, an embodiment further provides a connection establishment method. The method includes a control network element receives first information from a first core network element, where the first information indicates a location of a terminal device. The control network element sends connection information of a first network element to the terminal device based on the first information, where the first network element is a network element in a first edge network corresponding to a user plane network element serving the terminal device, and the connection information is used for the terminal device to connect to the first network element. In some embodiments, the terminal device obtains connection information of the control network element in at least one edge network from the connection information of the first network element, and establish a connection between the terminal device and the first network element based on the connection information. The edge network does not need to be preconfigured for the terminal device in some embodiments. The terminal device establishes the connection between the terminal device and the first network element based on the connection information that is of the first network element and that is determined by the control network element. In this case, connection establishment is dynamically triggered based on the location of the terminal device, and a success rate of establishing a connection between the terminal device and the edge network is improved.

In some embodiments, before that a control network element receives first information from a first core network element, the method further includes: The control network element sends location request information to the first core network element, where the location request information requests the first core network element to send the first information. Alternatively, the control network element sends subscription request information to the first core network element, where the subscription request information requests the first core network element to send the first information in response to detecting that the location of the terminal device changes, the subscription request information requests the first core network element to send the first information in response to detecting that the edge network corresponding to the user plane network element changes, or the subscription request information requests the core network element to send the first information in response to detecting that a user plane management event occurs. In this solution, the control network element further sends the subscription request information to the core network element, and the core network element receives the subscription request information sent by the at least one control network element. The core network element detects, based on the subscription request information, whether the location of the terminal device changes, detects whether the edge network corresponding to the user plane network element changes, or detects whether the user plane management event occurs. The core network element sends the first information in response to detecting that the location of the terminal device changes, send the first information in response to detecting that the edge network corresponding to the user plane network element changes, or send the first information in response to detecting that the user plane management event occurs. Therefore, the core network element sends the foregoing first information to the control network element by using the subscription request information sent by the control network element to the core network element, and the control network element sends the connection information of the first network element based on the first information, so that the terminal device is connected to the first edge network by using the connection information.

In some embodiments, a plurality of edge networks correspond to the user plane network element. After the control network element receives the first information from the first core network element, the method further includes: The control network element selects at least one edge network from the plurality of edge networks as the first edge network based on at least the location of the terminal device; or the control network element selects, based on at least the location of the terminal device, at least one network element from network elements included in the plurality of edge networks as the first network element.

In some embodiments, that the control network element sends connection information of a first network element to the terminal device based on the first information includes: The control network element sends the connection information to the terminal device based on the first information by using a second core network element. In some embodiments, after receiving the connection information of the first network element sent by the control network element, the first core network element sends the connection information of the first network element to the second core network element, and the second core network element sends the connection information of the first network element to the terminal device. In this way, the terminal device receives the connection information by using the second core network element.

In some embodiments, the first network element includes at least one of the following: a first control network element in the first edge network and a first application network element in the first edge network.

In some embodiments, the method further includes after the terminal device establishes a connection with the first control network element, the first control network element sends application information of the first application network element to the terminal device. In some embodiments, the terminal device receives the application information sent by the first control network element in the first edge network, the terminal device parses the application information to determine the first application network element included in the first edge network to which the terminal device establishes a connection, and the terminal device initiates an access request to the first application network element. In this way, the terminal device completes an entire process of application discovery.

According to a sixth aspect, an embodiment further provides a connection establishment method. The method includes a first core network element sends first information to a control network element, where the first information indicates a location of a terminal device. The control network element receives the first information from the first core network element. The control network element sends connection information of a first network element to the terminal device based on the first information, where the first network element is a network element in a first edge network corresponding to a user plane network element serving the terminal device, and the connection information is used for the terminal device to connect to the first network element. The terminal device receives the connection information of the first network element. The terminal device establishes a connection between the terminal device and the first network element based on the connection information. In some embodiments, the terminal device obtains connection information of the control network element in at least one edge network from the connection information of the first network element, and establish a connection between the terminal device and the first network element based on the connection information. The edge network does not need to be preconfigured for the terminal device in some embodiments. The terminal device establishes the connection between the terminal device and the first network element based on the connection information that is of the first network element and that is determined by the control network element. In this case, connection establishment is dynamically triggered based on the location of the terminal device, and a success rate of establishing a connection between the terminal device and the edge network is improved.

According to a seventh aspect, an embodiment provides a communication apparatus. The communication apparatus is specifically a control network element. The control network element is configured to perform the method according to the first aspect or the fifth aspect.

According to an eighth aspect, an embodiment provides a communication apparatus. The communication apparatus is specifically a core network element. The core network element is configured to perform the method according to any embodiment of the second aspect.

According to a ninth aspect, an embodiment provides a communication apparatus. The communication apparatus is a chip or a terminal device. The chip or the terminal device is configured to perform the method according to any embodiment of the third aspect.

In the seventh aspect, the eighth aspect, or the ninth aspect of some embodiments, composition modules of the communication apparatus further perform the steps described in the first aspect, the second aspect, the third aspect, the fifth aspect, and some embodiments thereof. For details, refer to the descriptions in the first aspect, the second aspect, the third aspect, the fifth aspect, and some embodiments thereof.

According to a tenth aspect, an embodiment provides a communication system. The communication system includes a control network element, a core network element, and a terminal device. The control network element is configured to perform the method performed by the control network element in the fourth aspect. The core network element is configured to perform the method performed by the core network element in the fourth aspect. The terminal device is configured to perform the method performed by the terminal device in the fourth aspect.

In some embodiments, the communication system further includes at least one of the following: a user plane network element and an application network element.

According to an eleventh aspect, an embodiment provides a communication system. The communication system includes a control network element, a first core network element, and a terminal device. The control network element is configured to perform the method performed by the control network element in the sixth aspect. The first core network element is configured to perform the method performed by the first core network element in the sixth aspect. The terminal device is configured to perform the method performed by the terminal device in the sixth aspect.

In some embodiments, the communication system further includes at least one of the following: a second core network element, a user plane network element, and an application network element.

According to a twelfth aspect, an embodiment provides a computer-readable storage medium. The computer-readable storage medium stores instructions. In response to the instructions running on a computer, the computer is enabled to perform the method according to any one of the first aspect, the second aspect, the third aspect, the fourth aspect, the fifth aspect, or the sixth aspect.

According to a thirteenth aspect, an embodiment provides a computer program product including instructions. In response to the computer program product running on a computer, the computer is enabled to perform the method according to any one of the first aspect, the second aspect, the third aspect, the fourth aspect, the fifth aspect, or the sixth aspect.

According to a fourteenth aspect, an embodiment provides a communication apparatus. The communication apparatus includes an entity such as a control network element, a core network element, and a terminal device or a chip. The communication apparatus includes a processor, and optionally, further includes a memory. The memory is configured to store instructions. The processor is configured to execute the instructions in the memory, to enable the communication apparatus to perform the method according to any one of the first aspect, the second aspect, the third aspect, the fourth aspect, the fifth aspect, or the sixth aspect.

According to a fifteenth aspect, some embodiments provide a chip system. The chip system includes a processor and is configured to support a control network element, a core network element, and a terminal device in implementing functions in the foregoing aspects, for example, sending or processing data and/or information in the foregoing methods. In an embodiment, the chip system further includes a memory. The memory is configured to store program instructions and data that are for the control network element, the core network element, and the terminal device. The chip system includes a chip, or include a chip and another discrete component.

### BRIEF DESCRIPTION OF DRAWINGS

FIG. 1a is a schematic structural composition diagram of a communication system according to some embodiments;

FIG. 1b is a schematic structural composition diagram of another communication system according to some embodiments;

FIG. 1c is a schematic structural composition diagram of another communication system according to some embodiments;

FIG. 2 is a schematic flowchart of interaction between a control network element, a core network element, and a terminal device in a connection establishment method according to some embodiments;

FIG. 3a is a schematic structural composition diagram of another communication system according to some embodiments;

FIG. 3b is a schematic structural composition diagram of another communication system according to some embodiments;

FIG. 4 is a schematic flowchart of interaction between a control network element, a first core network element, and a terminal device in a connection establishment method according to some embodiments;

FIG. 5a is a schematic diagram of an application scenario of a communication system according to some embodiments;

FIG. 5b is a schematic diagram of another application scenario of a communication system according to some embodiments;

FIG. 6 is a schematic flowchart of interaction between a plurality of network elements in a communication system according to some embodiments;

FIG. 7 is a schematic flowchart of interaction between a plurality of network elements in a communication system according to some embodiments;

FIG. 8 is a schematic flowchart of interaction between a plurality of network elements in a communication system according to some embodiments;

FIG. 9 is a schematic structural composition diagram of a control network element according to some embodiments;

FIG. 10 is a schematic structural composition diagram of a core network element according to some embodiments;

FIG. 11 is a schematic structural composition diagram of a terminal device according to some embodiments;

FIG. 12 is a schematic structural composition diagram of a control network element according to some embodiments;

FIG. 13 is a schematic structural composition diagram of a core network element according to some embodiments; and

FIG. 14 is a schematic structural composition diagram of a terminal device according to some embodiments.

### DESCRIPTION OF EMBODIMENTS

Embodiments provide a connection establishment method, a communication apparatus, and a system, to improve a success rate of establishing a connection by a terminal device with an edge network.

The following describes embodiments with reference to the accompanying drawings.

In the specification, claims, and accompanying drawings of some embodiments, the terms “first”, “second”, and so on are intended to distinguish between similar objects but do not indicate an order or sequence. Terms are used in such a way are interchangeable in proper circumstances, which is a discrimination manner that is used for objects having a same attribute are described in embodiments. In addition, the terms “include”, “contain” and any other variants mean to cover the non-exclusive inclusion, so that a process, method, system, product, or device that includes a series of units is not limited to those units, but includes other units not expressly listed or inherent to such a process, method, system, product, or device.

The technical solutions in embodiments are applied to various communication systems for data processing. The technical solutions provided in the embodiments are applied to various communication systems, for example, a long term evolution (long term evolution, LTE) system, a 5th generation (5th generation, 5G) communication system, and another similar communication system. In addition, the communication systems are further used in future-oriented communication technologies and are used in the technical solutions provided in embodiments. The system architecture and the service scenario described in embodiments are intended to describe the technical solutions in embodiments more clearly, and do not constitute a limitation on the technical solutions provided in embodiments. A person skilled in the art knows that: With the evolution of the network architecture and the emergence of new service scenarios, the technical solutions provided in embodiments are further applicable to similar technical problems.

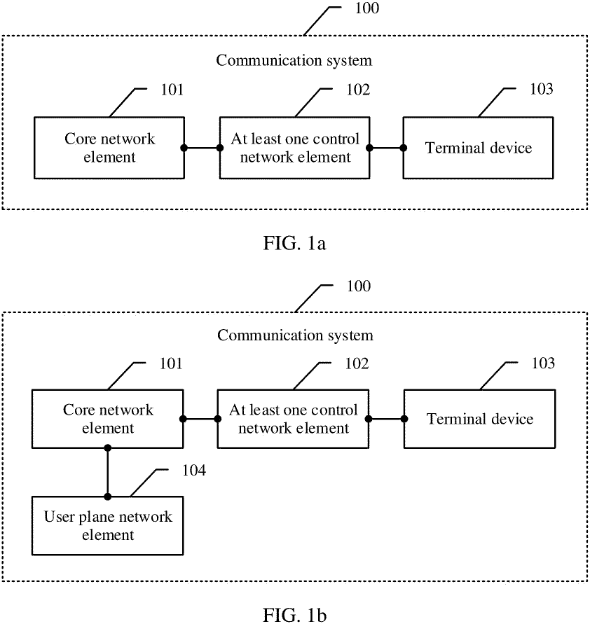

FIG. 1a is a schematic structural composition diagram of a communication system according to some embodiments. The communication system 100 provided in some embodiments include a core network element 101, at least one control network element 102, and a terminal device 103.

The core network element 101 is configured to send first information to at least one control network element 102, where the first information indicates that an edge network corresponding to a user plane network element serving the terminal device 103 changes.

The at least one control network element 102 is configured to send connection information of a first network element to the terminal device 103 based on the first information, where the first network element is a network element in a first edge network corresponding to the user plane network element, and the connection information is used for the terminal device to connect to the first network element.

The terminal device 103 is configured to establish a connection between the terminal device and the first network element based on the connection information of the first network element.

The core network element 101 separately communicates with the control network element 102 and the terminal device 103. For example, the core network element 101 directly communicates with the control network element 102, or indirectly communicates with the control network element 102 by using another network element in the communication system. Details are not limited herein. For another example, the core network element 101 directly communicates with the terminal device 103, or indirectly communicates with the terminal device 103 by using another network element in the communication system. Details are not limited herein. Optionally, in some embodiments, the core network element 101 has a function of obtaining a location of the terminal device. For example, the core network element 101 obtains the location of the terminal device from a network element that implements an access and mobility management function (access and mobility management function, AMF). The core network element 101 further determines, based on the location of the terminal device, whether the edge network corresponding to the user plane network element serving the terminal device changes. In response to the edge network corresponding to the user plane network element serving the terminal device changes, the core network element 101 generates the first information, and sends the first information to the control network element 102.

Optionally, the core network element 101 further receives, from the control network element 102, the connection information of the first network element, and send the connection information of the first network element to the terminal device 103. There are a plurality of embodiments for the core network element 101. For example, the core network element 101 is a network element that implements a session management function (session management function, SMF). For another example, the core network element 101 is specifically a network element that implements a policy control function (policy control function, PCF) in a core data center. For another example, the core network element 101 is specifically a network element that implements a network exposure function (network exposure function, NEF), and exposes a capability of the core network element to the control network element 102. Another core network element communicates with the control network element 102 by using the NEF. An embodiment of the core network element 101 is determined with reference to an application scenario. Details are not limited herein.

The communication system includes at least one control network element 102. The control network element 102 communicates with the core network element 101 and the terminal device 103. For example, the control network element 102 directly communicates with the core network element 101, or indirectly communicates with the core network element 101 by using another network element in the communication system. Details are not limited herein. For another example, the control network element 102 directly communicates with the terminal device 103, or indirectly communicates with the terminal device 103 by using another network element in the communication system. Details are not limited herein. In some embodiments, the communication system includes one or more control network elements 102. The control network element 102 has a function of obtaining the connection information of the first network element and communicates with the core network element 101. There are a plurality of embodiments for the control network element 102. For example, the control network element 102 is an application function network element (application function, AF) in an edge data center. In the 3rd generation partnership project (3rd generation partnership project,3GPP) system architecture (system and architecture, SA) 2, an application function network element or an application server deployed in a data center is uniformly referred to as an AF, and includes but is not limited to a control plane application network element (such as an edge enabler server (edge enabler server, EES) or a mobile edge computing platform (mobile edge computing platform, MEP), a user plane application network element (such as various application servers (application servers) or edge application servers (edge application servers, EASs). For example, the control network element 102 included in the communication system is a central control network element (further referred to as a central control network element) independent of the edge data center. For example, the central control network element is an edge configuration server (edge configuration server, ECS) or various application server controllers (application server controllers). The central control network element interacts with the control network element 102 in the local data center. An embodiment of the control network element 102 is determined with reference to an application scenario. Details are not limited herein. In some embodiments, there is no thorough difference between the control network element and the central control network element in the edge network. For example, the central control network element is deployed in an edge network. For example, the central control network element is deployed in a central data network. This is not limited in some embodiments.

The terminal device 103 included in the communication system receives, from the control network element 102, the connection information of the first network element, and then the terminal device 103 establishes the connection between the terminal device and the first network element. The terminal device 103 is a device that provides information, voice, and/or data connectivity for a user, and is further referred to as user equipment (user equipment, UE), a mobile station (mobile station, MS), a mobile terminal (mobile terminal, MT), or the like. Currently, for example, the terminal device 103 includes a mobile phone (mobile phone), a tablet computer, a notebook computer, a palmtop computer, a mobile internet device (mobile internet device, MID), a wearable device, a virtual reality (virtual reality, VR) device, an augmented reality (augmented reality, AR) device, a wireless terminal in industrial control (industrial control), a wireless terminal in self driving (self driving), a wireless terminal in remote medical surgery (remote medical surgery), a wireless terminal in a smart grid (smart grid), a wireless terminal in transportation safety (transportation safety), a wireless terminal in a smart city (smart city), a wireless terminal in a smart home (smart home), and a vehicle-mounted device. A related function of the terminal device 103 is implemented by using a chip, and steps performed by the terminal device in the embodiments is performed by the chip.

In some embodiments, an edge network is deployed at the edge of a data network. For example, the edge network is an environment (edge hosting environment, EHE) or a data center (data center, DC) of an edge application. The EHE is further referred to as an edge data network (edge data network, EDN). In the following embodiment, an example in which the edge network is the EDN is used for description. A control network element is deployed in the edge network. The control network element in the edge network is used for the terminal device to connect to the edge network. For example, in response to the edge network being an EDN, the control network element in the edge network is an EES. For example, in response to the edge network being an edge data center, the control network element in the edge network is an MEP. An application network element are further deployed in the edge network. The application network element in the edge network is used for the terminal device to connect to the edge network. The application network element are further configured to provide application information for the terminal device. For example, in response to the edge network being an EDN, the application network element is an EAS.

In some embodiments, the first edge network is one or more corresponding edge networks serving the terminal device, the first edge network is specifically an edge network that the terminal device connects to, and the first edge network is further referred to as a target edge network. The first edge network is configured to be connected to the terminal device. For example, the first edge network includes the first network element. Specifically, the terminal device establishes a connection with the first network element. The first network element is one or more network elements in the first edge network. There are a plurality of embodiments for the first network element. For example, the first network element includes at least one of the following: a first control network element in the first edge network and a first application network element in the first edge network. In other words, the first network element is a control network element, or the first network element is an application network element.

In some embodiments, the connection information of the first network element is used for the terminal device to connect to the first network element. The connection information is an internet protocol (internet protocol, IP) address of the first network element, or a unique identifier of the first network element. Details are not limited herein. In addition, the connection information of the first network element sent by the control network element 102 is carried in edge network information for sending.

In some embodiments, as shown in FIG. 1b, the communication system 100 further includes a user plane network element 104. The user plane network element 104 is configured to serve the terminal device 103. The user plane network element 104 is disposed between the terminal device 103 and the edge network. For example, one user plane network element 104 is disposed between the terminal device 103 and each of a plurality of edge networks. The user plane network element 104 is configured to send delay information to the core network element 101. In response to there being a plurality of user plane network elements 104, each user plane network element sends one piece of delay information to the core network element 101, and the core network element 101 receives a plurality of pieces of delay information. Each piece of delay information includes a transmission delay between the terminal device 103 and one user plane network element 104. For example, the user plane network element 104 is specifically a network element that implements a user plane function (user plane function, UPF). Specifically, the user plane network element 104 is in a local data center (local data center) or close to the local data center. The user plane network element 104 is further referred to as a local protocol data unit anchor (local PDU session anchor, L-PSA). For example, the user plane network element 104 supports all or some of the following functions: interconnecting a protocol data unit (protocol data unit, PDU) session with a data network, packet routing and transfer (for example, supporting transfer of traffic to the data network after uplink classification), and data packet detection. For example, the user plane network element 104 further measures a transmission delay between the terminal device and the user plane network element.

In some embodiments, as shown in FIG. 1c, the communication system 100 further includes an application network element 105. After the connection between the terminal device 103 and the first network element is established, the terminal device 103 receives application information of the application network element 105, the terminal device sends an access request to the application network element 105 based on the application information, and the application network element 105 is configured to receive the access request sent by the terminal device. For example, the application network element 105 is the first application network element in the first edge network.

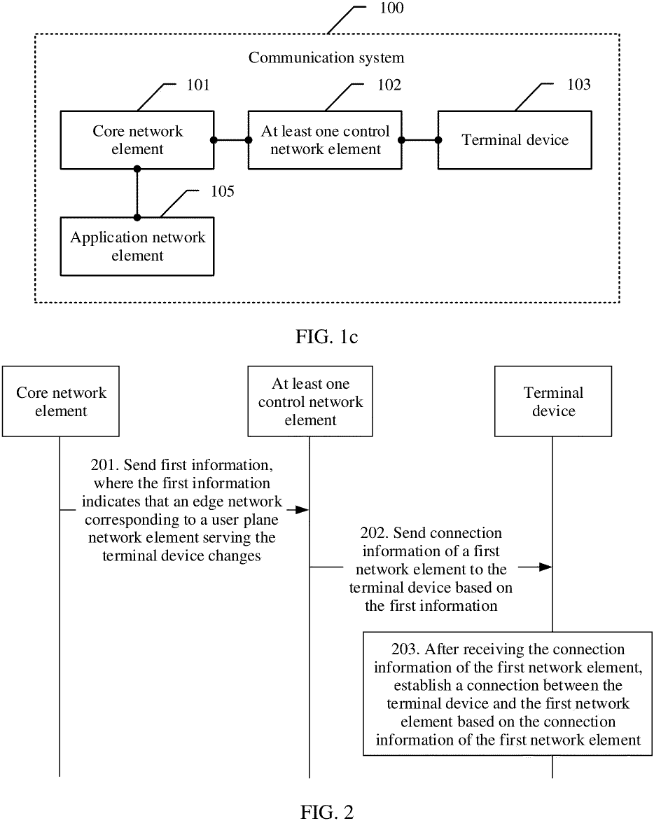

The foregoing embodiment describes the communication system. The following describes a connection establishment method performed based on the communication system. Referring to FIG. 2, the connection establishment method provided in an embodiment of some embodiments includes the following steps.

201. A core network element sends first information to at least one control network element, where the first information indicates that an edge network corresponding to a user plane network element serving a terminal device changes.

The first information is specifically a notification message sent by the core network element to the at least one control network element. For example, the notification message is specifically a data network access identifier (data network access identifier, DNAI) change message (change notification) or a user plane management event notification message (user plane management event notification).

In some embodiments, the first information indicates that the edge network corresponding to the user plane network element serving the terminal device changes. Alternatively, in some embodiments the first information indicates that the user plane network element (for example, a UPF) serving a session of the terminal device changes or a user plane path of a session of the terminal device changes. Alternatively, that the first information indicates that the edge network corresponding to the user plane network element serving the terminal device changes is understood as: After the terminal device moves, an edge network that the terminal device accesses changes. For example, a form or an information name of the first information is not limited in some embodiments. In an embodiment, a user plane path between each user plane network element (for example, a UPF) and an edge network has a unique DNAI identifier. In response to a user plane network element serving UE changes, an edge network that provides a service for the terminal device changes. In another embodiment, there are N user plane network elements (for example, UPFs), and the N user plane network elements correspond to a same edge network. In other words, the N UPFs serve one edge network, and a value of N is a positive integer. The user plane path between each UPF and the edge network has a different DNAI identifier. In response to the user plane network element serving the UE changes, the edge network that provides a service for the terminal device is unable to change. Before the core network element sends the first information to the at least one control network element, the control network element sends subscription request information to the core network element, where the subscription request information requests the core network element to send the first information in response to detecting that a user plane management event occurs. Correspondingly, the first information indicates that the user plane management event occurs.

Optionally, the first information further includes a location of the terminal device. In an embodiment, the core network element sends a DNAI change notification or a user plane management event notification message (user plane management event notification) to the at least one control network element, where the notification message further carries the location of the terminal device. The location of the terminal device is represented in a plurality of manners. The location of the terminal device includes a DNAI identifier that indicates an identifier of a path between an edge network and the user plane network element serving the terminal device, or include a list of candidates and available DNAIs adjacent to the terminal device (where the list of DNAIs indicates the control network element to determine an appropriate edge network or determine information about an appropriate control network element). Alternatively, the location of the terminal device is UE location information, for example, a tracking area identity (tracking area identity, TAI) and a cell identifier (Cell ID). The control network element determines, based on the location of the terminal device, connection information to be sent to the terminal device. In an embodiment, a user plane path between each user plane network element (for example, a UPF) and an edge network has a unique DNAI identifier. After receiving a DNAI identifier, the control network element determines that an edge network corresponding to the DNAI identifier is an edge network currently most suitable for serving the UE. Therefore, the control network element sends connection information of a first network element to the terminal device. The first network element is a network element in the edge network corresponding to the DNAI identifier.

It is understood that “the edge network corresponding to the user plane network element serving the terminal device changes” is “one edge network corresponding to one user plane network element serving the terminal device changes”, or “a plurality of edge networks corresponding to a plurality of user plane network elements serving the terminal device change”.

In some embodiments, the core network element obtains the location of the terminal device. For example, the core network element obtains the location of the terminal device from an AMF. The core network element determines, based on the location of the terminal device, whether the edge network corresponding to the user plane network element serving the terminal device changes. For example, the terminal device moves, and a location to which the terminal device moves is not within a service range of the edge network currently corresponding to the user plane network element serving the terminal device. In this case, the core network element determines that the edge network corresponding to the user plane network element serving the terminal device changes. The core network element generates first information. The first information indicates that the edge network corresponding to the user plane network element serving the terminal device changes. For example, the first information is data network access identifier (data network access identifier, DNAI) update (change) information, and is specifically a DNAI change notification. The DNAI change information indicates that a DNAI change event occurs. Alternatively, the core network element determines that a user plane network element (for example, a UPF) serving a current session of the terminal device changes and determines that a DNAI corresponding to the user plane network element changes. The first information is a user plane management event notification, and the user plane management event notification carries a changed DNAI. Alternatively, the core network element (for example, an SMF) detects whether a user plane path of the terminal device changes. For example, in response to detecting that an event such as a local UPF is dynamically inserted or an anchor UPF is switched occurs, the core network element (SMF) sends first information. The first information indicates that the user plane path of the terminal device changes. The first information is specifically a notification message, for example, a user plane management event notification. Optionally, the first information further includes a DNAI identifier that indicates an identifier of a path between the edge network and the user plane network element serving the terminal. Alternatively, the notification message includes a list of candidates and available DNAIs adjacent to the terminal, indicating the control network element to select an appropriate edge network or determine information about an appropriate control network element. Alternatively, the notification message includes UE location information, such as a TAI and a Cell ID.

After generating the first information, the core network element sends the first information to the at least one control network element, so that the at least one control network element receives the first information from the core network element. For implementations of the core network element and the control network element, refer to the detailed descriptions in the foregoing embodiments. Details are not described herein again.

In some embodiments, before step 201 in which the core network element sends the first information to the at least one control network element, the method provided in some embodiments further includes:

The control network element sends subscription request information to the core network element, where the subscription request information requests the core network element to send the first information in response to detecting that the location of the terminal device changes, the subscription request information requests the core network element to send the first information in response to detecting that the edge network corresponding to the user plane network element changes, or the subscription request information requests the core network element to send the first information in response to detecting that the user plane management event occurs.

In some embodiments, before step 201 in which the core network element sends the first information to the at least one control network element, the method further includes:
The core network element receives location request information sent by the at least one control network element, where the location request information requests the core network element to send the location of the terminal device; or
the core network element receives subscription request information sent by the control network element, where the subscription request information requests the core network element to send the first information in response to detecting that the location of the terminal device changes, the subscription request information requests the core network element to send the first information in response to detecting that the edge network corresponding to the user plane network element changes, or the subscription request information requests the core network element to send the first information in response to detecting that the user plane management event occurs.

Specifically, the core network element receives the location request information sent by the control network element. The core network element determines, based on the location of the terminal device, whether the edge network corresponding to the user plane network element serving the terminal device changes, and send the first information in response to the edge network corresponding to the user plane network element serving the terminal device changes.

The control network element further sends the subscription request information to the core network element, and the core network element receives the subscription request information sent by the at least one control network element. The core network element detects, based on the subscription request information, whether the location of the terminal device changes, detects whether the edge network corresponding to the user plane network element changes, or detects whether the user plane management event occurs. The core network element sends the first information in response to detecting that the location of the terminal device changes, send the first information in response to detecting that the edge network corresponding to the user plane network element changes, or send the first information in response to detecting that the user plane management event occurs. The at least one control network element that receives the first information is an AF, or is an EES, an ECS, an MEP, or the like. For example, the at least one control network element subscribes to the DNAI change (change) event or the user plane management (user plane management) event from the core network element. In response to detecting that the DNAI change event, or the user plane management event occurs, the core network element sends DNAI change information to the control network element, so that the control network element obtains an access location of the terminal device. Optionally, the first information further includes a DNAI identifier, or the first information includes a list (list) of potentially candidate DNAIs. The list of DNAIs includes one or more DNAI identifiers.

202. The at least one control network element sends the connection information of the first network element to the terminal device based on the first information, where the first network element is a network element in a first edge network corresponding to the user plane network element.

In some embodiments, the at least one control network element receives the first information, and determines, based on the first information, that the edge network corresponding to the user plane network element serving the terminal device changes, or determines, based on the first information, that the user plane management event of the terminal device occurs. The at least one control network element obtains the connection information of the first network element. The at least one control network element sends the connection information of the first network element to the terminal device. For example, the control network element sends the connection information of the first network element to the terminal device by using a user plane path or an application layer-based method, or the control network element sends the connection information of the first network element to the terminal device via the core network element.

The control network element stores or configures information about one or more edge networks, and the control network element further obtains information about an edge network from another network element. The first edge network refers to an edge network that is determined by the control network element and notified to the terminal device. The first edge network is further referred to as a target edge network. In an embodiment, the control network element has information about N edge networks, and the control network element determines to send information about M edge networks or some information about the M edge networks to the terminal device. M is less than or equal to N, and M is greater than or equal to 0. A network element in the first edge network is configured to be connected to the terminal device. For example, the first edge network includes a first network element. Specifically, the terminal device establishes a connection with the first network element. The first network element is one or more network elements in the first edge network. There are a plurality of embodiments for the first network element. For example, the first network element includes at least one of the following: a first control network element in the first edge network and a first application network element in the first edge network. In other words, the first network element is a control network element, for example, the first network element is an EES, or the first network element is an application network element, for example, the first network element is an EAS.

In some embodiments, the first edge network and the first network element is in an inclusion relationship, for example, the first edge network includes the first network element; or the first edge network and the first network element is in an association relationship, for example, a first network element serves a plurality of first edge networks.

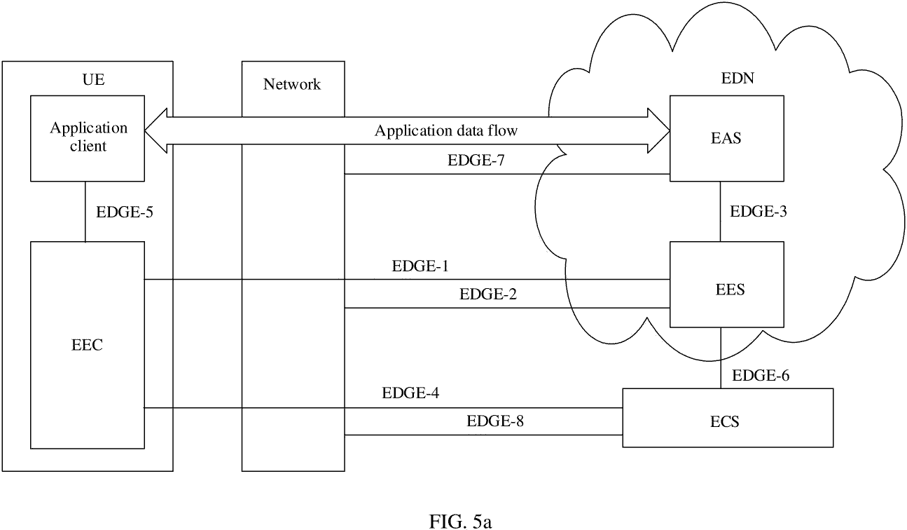

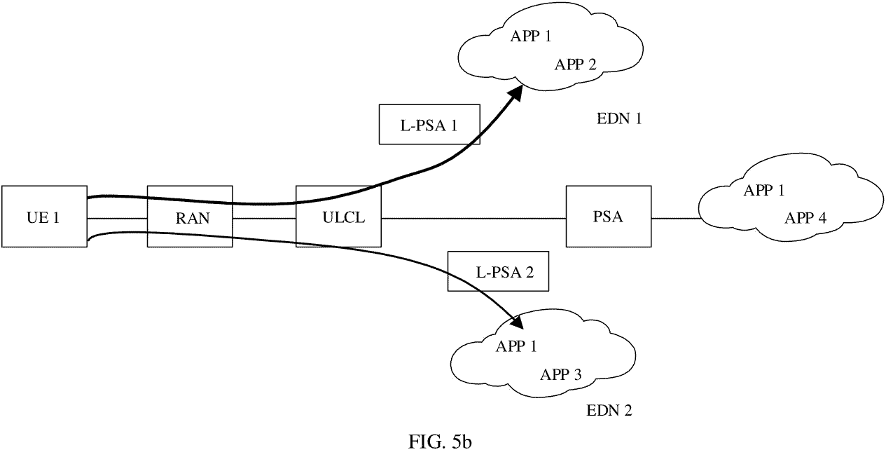

In an embodiment, the user plane network element corresponds to the first edge network, and the user plane network element is a user plane network element that is serving the terminal device. For example, in FIG. 5b, L-PSA 1 corresponds to EDN 1, and L-PSA 2 corresponds to EDN 2. In response to detecting that L-PSA 1 or L-PSA 2 is inserted, the core network element sends the first information to the control network element. After receiving the first information, the control network element delivers, to the terminal device, connection information of a network element in EDN 1 corresponding to L-PSA 1 and/or connection information of a network element in EDN 2 corresponding to L-PSA 2.

In another embodiment, the user plane network element corresponds to the first edge network, and the user plane network element is a user plane network element that has not served the terminal device. For example, information about an edge network, EDN 3, is configured on the control network element. EDN 3 is served by PSA 3, and an association relationship between PSA 3 and EDN 3 is identified by using a DNAI. As shown in FIG. 5b, the terminal device is not served by PSA 3. In response to detecting that L-PSA 1 or L-PSA 2 is inserted, the core network element sends the first information to the control network element. After receiving the first information, the control network element delivers, to the terminal device, connection information of a network element in EDN 3 corresponding to PSA 3.

In some embodiments, the connection information of the first network element is used for the terminal device to connect to the first network element. The connection information includes but is not limited to the following information of the first network element: an IP address, a uniform resource locator (uniform resource identifier, URI), a uniform resource locator (uniform resource locator, URL), a fully qualified domain name (fully qualified domain name, FQDN), and an identifier of the first network element. For example, the identifier of the first network element includes an EAS ID.

In an embodiment, the connection information of the first network element includes connection information of the first control network element in the first edge network corresponding to the user plane network element serving the terminal device, and the connection information of the first control network element is used for the terminal device to establish a connection with the first control network element. In another embodiment, the connection information of the first network element includes connection information of the first application network element in the first edge network corresponding to the user plane network element serving the terminal device, and the connection information of the first application network element is used for the terminal device to establish a connection with the first application network element. The connection information of the first application network element specifically includes an address (for example, an IP address, a URI, or a URL) of the first application network element, identification information of the first application network element, an FQDN of the first application network element, or the like.

In some embodiments, “the terminal device establishes a connection with an edge network” is “the terminal device establishes a connection with a control network element in the edge network”, or “the terminal device establishes a connection with an application network element in the edge network”.

In some embodiments, in addition to performing the foregoing method, the core network element further performs the following step in the connection establishment method provided in some embodiments.

The core network element receives indication information sent by the at least one control network element, where the indication information indicates the core network element to send the connection information of the first network element to the terminal device.

The at least one control network element sends the connection information of the first network element to the terminal device via the core network element. For example, the control network element sends the connection information of the first network element to the core network element, where the connection information of the first network element further includes indication information, and the core network element sends the connection information of the first network element to the terminal device based on the indication information. In some embodiments, the indication information enables the core network element to send the connection information of the first network element to the terminal device, so that the terminal device receives the connection information of the first network element via the core network element.

For example, to indicate the core network element to send the connection information of the first network element to the terminal device, the at least one control network element includes one piece of indication information in the connection information of the first network element. For example, the indication information is carried in a field in the connection information of the first network element. For example, the indication information is carried in a reserved field in the connection information of the first network element, or the indication information is carried in a new field obtained through extension in a message sent to the core network element. That is, the connection information of the first network element includes the indication information. The connection information of the first network element and the indication information is alternatively two pieces of information. An embodiment is not limited herein.

In some embodiments, the connection information of the first network element further includes service range information of the first edge network.

The service range information of the first edge network indicates the terminal device to establish a connection with the first network element in the first edge network in response to the terminal device being in a service range of the first edge network.

Specifically, the service range information of the first edge network includes the service range of the first edge network. After receiving the connection information of the first network element, the terminal device obtains the service range information of the first edge network from the connection information of the first network element. In this way, the terminal device establishes a connection with the control network element in the first edge network in response to the terminal device being in the service range of the first edge network. In some embodiments, the terminal device does not establish a connection with the first network element in the first edge network in response to the terminal device not being within the service range of the first edge network.

In some embodiments, the first information further includes a location of the terminal device. The location of the terminal device is used for the at least one control network element to determine the first edge network or determine the first network element.

The connection establishment method provided in some embodiments further includes:
The control network element determines the first edge network or determines the first network element based on at least the location of the terminal device.
The core network element sends the first information to the at least one control network element, and the first information further includes the location of the terminal device. In this case, the control network element obtains the location of the terminal device by using the first information. The location of the terminal device is represented in a plurality of manners. The location of the terminal device includes a DNAI identifier that indicates an identifier of a path between an edge network and the user plane network element serving the terminal, or include a list of candidate and available DNAIs adjacent to the terminal, where the list of DNAIs indicates the control network element to determine an appropriate edge network or determine information about an appropriate control network element. Alternatively, the location of the terminal device is UE location information, for example, a TAI and a Cell ID. The control network element determines, based on the location information, connection information to be sent to the terminal device. In an embodiment, a user plane path between each user plane network element (for example, a UPF) and an edge network has a unique DNAI identifier. After receiving one or more DNAI identifiers, the control network element determines that an edge network corresponding to the DNAI identifier is an edge network currently most suitable for serving the UE, that is, determine that an edge network corresponding to the DNAI identifier is a first network. The first network element is a network element in the edge network corresponding to the DNAI identifier. The control network element sends the connection information of the first network element to the terminal device. In another embodiment, service range information of the edge network is configured on the control network element. In response to the first information including the location of the terminal device, the control network element determines that an edge network whose service range information includes the location of the terminal device is the first edge network, and the first network element is a network element in the first edge network. In another embodiment, service range information of a network element in the edge network is configured on the control network element. In response to the first information including the location of the terminal device, the control network element determines that a network element whose service range includes the location of the terminal device is the first network element. The control network element determines the first edge network or determines the first network element based on at least the location of the terminal device. In other words, the control network element determines, based on the location of the terminal device, the first edge network in a plurality of edge networks corresponding to a plurality of user plane network elements serving the terminal device. Alternatively, the control network element determines, based on the location of the terminal device, the first network element in network elements in a plurality of edge networks. In some embodiments, the control network element first determines the first edge network based on the location of the terminal device, and then determine the first network element in the first edge network. Details are not limited. Alternatively, the control network element directly determines the first network element in network elements in a plurality of edge networks. For example, in response to a plurality of edge networks corresponding to a plurality of UPFs serving the terminal device include a plurality of EESs, and each EES has a corresponding service range, the control network element determines the first network element in the plurality of EESs based on the location of the terminal device.

In some embodiments, the at least one control network element is a central control network element; a plurality of edge networks correspond to the user plane network element; the first edge network is at least one edge network selected by the central control network element from the plurality of edge networks; or the first network element is at least one network element selected by the central control network element from network elements included in the plurality of edge networks.

Step 202 in which the at least one control network element sends the connection information of the first network element to the terminal device based on the first information includes:
A1. The central control network element selects at least one edge network from the plurality of edge networks as the first edge network.
A2. Alternatively, the central control network element selects at least one network element from network elements included in the plurality of edge networks as the first network element.
A3. The central control network element sends the connection information to the terminal device.

A central control network element is disposed in the communication system. The central control network element is independent of a control network element in each edge network. In addition, the central control network element interacts with the core network element, and the central control network element further interacts with the control network element in each edge network. For example, the central control network element is an ECS or a globally management controller AF.

In some embodiments, after the central control network element receives the first information, the central control network element determines, for the terminal device, an edge network to which a connection needs to be established. The edge network to which a connection needs to be established is referred to as the first edge network. A plurality of edge networks corresponds to the user plane network element. For example, the central control network element selects M (M≤N, M≥1) edge networks from N edge networks as the first edge networks. M is equal to 1, and in this case, one first edge network is selected from the N edge networks. Alternatively, M is greater than 1, and in this case, a plurality of first edge networks are selected from the N edge networks. In the following embodiment, an example in which the central control network element selects at least one edge network from the plurality of edge networks as the first edge network is used for description.

In some embodiments, the central control network element selects the first edge network from the plurality of edge networks, or selects the first network element from the network elements included in the plurality of edge networks. In this case, the central control network element sends the connection information of the selected first network element to the terminal device, so that the terminal device establishes a connection with the first network element selected by the central control network element from the first edge network, thereby improving a success rate of establishing a connection by the terminal device with the edge network.

In some embodiments, the central control network element selects at least one edge network from a plurality of edge networks as the first edge network by using a preset edge network selection policy. The edge network selection policy includes a plurality of embodiments. For example, the edge network selection policy is determined based on a delay of a transmission channel, or the edge network selection policy is determined based on load of an edge network. For example, the edge network selection policy is determined based on a DNAI, and service range information of an EDN. Details are not limited. The edge network selection policy are further used to select the first network element. Details are not limited.

Further, in some embodiments, the connection establishment method performed by the core network element further includes the following steps:

The core network element receives delay information from a plurality of user plane network elements, where each piece of delay information includes a transmission delay between the terminal device and one user plane network element.

The core network element sends, to the central control network element, the delay information from the plurality of user plane network elements, where the delay information is used for the central control network element to: select at least one edge network from the plurality of edge networks as the first edge network, or select at least one network element from network elements included in the plurality of edge networks as the first network element.

In the foregoing implementation scenario in which step A1 to step A3 are performed, the connection establishment method provided in some embodiments includes the following steps.

B 1. The central control network element receives a plurality of pieces of delay information from the core network element, where each piece of delay information includes a transmission delay between the terminal device and one user plane network element.

As shown in FIG. 1b, the communication system 100 further includes a user plane network element 104. The user plane network element 104 is configured to serve the terminal device 103. The user plane network element 104 is disposed between the terminal device 103 and the edge network. For example, one user plane network element 104 is disposed between the terminal device 103 and each of a plurality of edge networks. Each user plane network element is configured to measure a delay corresponding to a transmission channel between the terminal device and the user plane network element. For example, the user plane network element is an L-PSA, and the transmission channel between the terminal device and the user plane network element includes UE-radio access network (radio access network, RAN), RAN-uplink classifier (uplink classifier, ULCL), and ULCL-L-PSA. Each user plane network element sends delay information to the core network element, the core network element receives a plurality of pieces of delay information, and then the core network element sends the plurality of pieces of delay information to the central control network element.

Step A1 in which the central control network element selects at least one edge network from the plurality of edge networks as the first edge network includes: The central control network element selects at least one edge network from the plurality of edge networks as the first edge network based on at least a plurality of pieces of delay information.

Alternatively, step A2 in which the central control network element selects at least one network element from network elements included in the plurality of edge networks as the first network element includes: The central control network element selects at least one network element from the network elements included in the plurality of edge networks as the first network element based on at least the plurality of pieces of delay information.

The core network element communicates with the central control network element. For example, the core network element establishes a communication connection with the central control network element, and the core network element receives the plurality of pieces of delay information by using the communication connection. The central control network element selects at least one edge network from the plurality of edge networks as the first edge network based on at least the plurality of pieces of delay information or selects at least one network element from the network elements included in the plurality of edge networks as the first network element. For example, the central control network element determines the first edge network or the first network element based on a plurality of pieces of delay information. Alternatively, the central control network element determines the first edge network or the first network element based on a plurality of pieces of delay information and the location of the terminal device. A manner of determining the first edge network or the first network element depends on the edge network selection policy used by the central control network element. For example, the central control network element selects an edge network corresponding to a transmission path with a minimum delay as the first edge network, or the central control network element selects a network element in an edge network corresponding to a transmission path with a minimum delay as the first network element.

In some embodiments, the central control network element selects the first edge network from the plurality of edge networks based on at least the delay information, or selects, based on at least the delay information, the first network element from the network elements included in the plurality of edge networks. In this case, the central control network element sends the connection information of the selected first network element to the terminal device, so that the terminal device establishes a connection with the first network element selected by the central control network element from the first edge network, thereby improving a success rate of establishing a connection by the terminal device with the edge network.

In some embodiments, in addition to determining the first edge network or the first network element based on the delay information, the central control network element further determines the first edge network or the first network element based on an edge network load balancing policy. Details are not limited. Alternatively, the central control network element determines the first edge network, or the first network element based on both the delay information and the edge network load balancing policy. A manner of selecting the first edge network and the first network element is not limited.

In some embodiments, after determining the first edge network, the central control network element determines the first network element in the first edge network, and then the central control network element sends the connection information of the first network element to the terminal device. For example, the connection information of the first network element includes the connection information of the first control network element and/or the first application network element. For example, the central control network element stores connection information of a control network element and/or an application network element in each edge network. The central control network element obtains the connection information of the first control network element and/or the first application network element based on the locally stored connection information of the control network element and/or the application network element. For another example, the central control network element communicates with a control network element in each edge network. After determining the first edge network, the central control network element communicates with the first control network element in the first edge network, to obtain the connection information of the first control network element and/or the first application network element.

In some embodiments, the at least one control network element is a central control network element, one edge network corresponds to the user plane network element, and the one edge network corresponding to the user plane network element is the first edge network.

Step 202 in which the at least one control network element sends the connection information of the first network element to the terminal device based on the first information includes:

The central control network element selects at least one network element from network elements in the first edge network as the first network element.

The central control network element sends the connection information to the terminal device.

A central control network element is disposed in the communication system. The central control network element is independent of a control network element in an edge network. In addition, the central control network element interacts with the core network element, and the central control network element further interacts with the control network element in the edge network. For example, the central control network element is an ECS or a globally management controller AF.

In some embodiments, after the central control network element receives the first information, the central control network element determines, for the terminal device, an edge network to which a connection needs to be established. The edge network to which a connection needs to be established is referred to as the first edge network. One edge network corresponds to the user plane network element. For example, the central control network element selects T network elements from S network elements in an edge network as the first network element. T is equal to 1, and in this case, one first network element is selected from the S network elements. Alternatively, T is greater than 1, and in this case, a plurality of first network elements are selected from the S network elements. In the following embodiment, an example in which the central control network element selects at least one network element from the first edge network as the first network element is used for description.

In some embodiments, the central control network element selects the first network element from the network elements included in the first edge network. In this case, the central control network element sends the connection information of the selected first network element to the terminal device, so that the terminal device establishes a connection with the first network element selected by the central control network element, thereby improving a success rate of establishing a connection by the terminal device with the edge network.

In some embodiments, the central control network element selects at least one network element from a plurality of network elements in the first edge network as the first network element by using a preset network element selection policy. The network element selection policy includes a plurality of embodiments. For example, the network element selection policy is determined based on a delay of a transmission channel. For example, the network element selection policy is determined based on a DNAI, and service range information of an EDN. Details are not limited.

In some embodiments, step 202 in which the at least one control network element sends the connection information of the first network element to the terminal device based on the first information includes:

The first control network element in the first edge network sends the connection information of the first network element to the terminal device, where the first network element includes a first control network element and/or a first application network element.

The communication system includes a plurality of control network elements, the plurality of control network elements respectively belong to different edge networks, and a control network element in each edge network sends connection information of a network element in the edge network to the core network element. In this case, the terminal device receives the connection information from the plurality of control network elements. For example, the communication system includes a plurality of first control network elements, the first control network element sends, to the terminal device, connection information of a first network element in a first edge network corresponding to the first control network element, and the first network element includes the first control network element and/or a first application network element. The terminal device receives connection information of first network elements in a plurality of first edge networks corresponding to a plurality of first control network elements. The terminal device selects a first edge network from a plurality of first edge networks corresponding to the plurality of first control network elements, and then establish a connection with a first network element in the selected first edge network.

In some embodiments, step 202 in which the at least one control network element sends the connection information of the first network element to the terminal device based on the first information includes:
C1. The at least one control network element sends the connection information of the first network element to the core network element.
C2. The core network element receives the connection information of the first network element sent by the at least one control network element, where the first network element is a network element in the first edge network corresponding to the user plane network element, and the connection information is used for the terminal device to connect to the first network element.
C3. The core network element sends the connection information of the first network element to the terminal device.

In some embodiments, the communication system includes at least one control network element. The control network element in the edge network sends, to the core network element, the connection information of the first network element in the first edge network corresponding to the control network element. In this case, the core network element receives, from the control network element, the connection information of the first network element, and the core network element sends the connection information of the first network element to the terminal device, so that the terminal device receives, from the core network element, the connection information of the first network element.

203. After receiving the connection information of the first network element, the terminal device establishes a connection between the terminal device and the first network element based on the connection information of the first network element.

The terminal device receives the connection information of the first network element from the at least one control network element. Alternatively, the terminal device establishes a communication connection with the core network element, and the terminal device receives the connection information of the first network element via the core network element. For example, the terminal device establishes a control plane connection (for example, non-access stratum (non-access stratum, NAS) signaling) or a user plane connection (between the UE and the UPF) with the core network element.

In some embodiments, the terminal device communicates with the core network element, the terminal device receives the connection information of the first network element from the core network element, the terminal device determines, based on the connection information of the first network element, the first network element to which a connection needs to be established, and the terminal device establishes the connection with the first network element. In this way, a process of establishing a connection between the terminal device and the edge network is completed. In some embodiments, the terminal device receives the connection information of the first network element, so that the terminal device no longer uses a preconfigured manner to establish the foregoing connection. In addition, the connection information of the first network element is generated based on the location of the terminal device, so that a success rate of establishing the connection between the terminal device and the first network element in the first edge network is improved.

In some embodiments, a plurality of edge networks correspond to the user plane network element.

Step 203 in which the terminal device establishes a connection between the terminal device and the first network element based on the connection information includes:
D1. The terminal device selects at least one edge network from the plurality of edge networks as the first edge network.
D2. The terminal device selects at least one network element from network elements included in the plurality of edge networks as the first network element.
D3. The terminal device establishes the connection between the terminal device and the first network element based on the connection information.

A terminal device is disposed in the communication system. The terminal device interacts with the core network element, and the terminal device further interacts with a control network element in each edge network. In some embodiments, after the terminal device receives connection information of a plurality of first network elements, the terminal device determines the first edge network to which the terminal device needs to establish a connection. A plurality of edge networks corresponds to the user plane network element. For example, the terminal device selects M (M≤N, M≥1) edge networks from N edge networks as the first edge networks. M is equal to 1, and in this case, one first edge network is selected from the N edge networks. Alternatively, M is greater than 1, and in this case, a plurality of first edge networks are selected from the N edge networks. In the following embodiment, an example in which the terminal device selects at least one edge network from the plurality of edge networks as the first edge network is used for description.

In some embodiments, the terminal device selects the first edge network from the plurality of edge networks, or selects the first network element from the network elements included in the plurality of edge networks, so that the terminal device establishes a connection with the first network element selected by the terminal device from the first edge network, thereby improving a success rate of establishing a connection by the terminal device with the edge network.

In some embodiments, the terminal device selects at least one edge network from a plurality of edge networks as the first edge network by using a preset edge network selection policy. The edge network selection policy includes a plurality of embodiments. For example, the edge network selection policy is determined based on a delay of a transmission channel, or the edge network selection policy is determined based on load of an edge network. For example, the edge network selection policy is determined based on a DNAI, and service range information of an EDN. Details are not limited. The edge network selection policy are further used to select the first network element. Details are not limited.

In the foregoing implementation scenario in which step D1 and step D2 are performed, the connection establishment method provided in some embodiments includes the following steps.

E1. The terminal device receives delay information of a plurality of user plane network elements sent by the core network element, where each piece of delay information includes a transmission delay between the terminal device and one user plane network element.

Step D1 in which the terminal device selects at least one edge network from the plurality of edge networks as the first edge network includes: The terminal device selects at least one edge network from the plurality of edge networks as the first edge network based on at least the delay information.

Step D2 in which the terminal device selects at least one network element from network elements included in the plurality of edge networks as the first network element includes: The terminal device selects at least one network element from the network elements included in the plurality of edge networks as the first network element based on at least the delay information.

The delay information is used for the terminal device to select at least one edge network from the plurality of edge networks as the first edge network, or select at least one network element from network elements included in the plurality of edge networks as the first network element.

In some embodiments, in addition to determining the first edge network or the first network element based on the delay information, the terminal device further determines the first edge network or the first network element based on the edge network load balancing policy, or determine the first edge network or the first network element based on both the delay information and the edge network load balancing policy. A manner of selecting the first edge network and the first network element is not limited.

In some embodiments, the terminal device selects the first edge network from the plurality of edge networks based on at least the delay information, or selects, based on at least the delay information, the first network element from the network elements included in the plurality of edge networks, so that the terminal device establishes a connection with the first network element selected by the terminal device from the first edge network, thereby improving a success rate of establishing a connection by the terminal device with the edge network.

In some embodiments, the connection establishment method provided in some embodiments further includes: The at least one control network element sends routing information to the user plane network element via the core network element.

The routing information indicates the user plane network element to send a data packet from the terminal device to an edge network corresponding to the user plane network element. The user plane network element sends, based on the routing information, the data packet from the terminal device to the edge network corresponding to the user plane network element. In some embodiments, the routing information sent by the network element is controlled, so that the data packet from the terminal device is automatically forwarded, and a transmission path of the data packet does not need to be indicated by using separate signaling, thereby reducing overheads.

In some embodiments, as shown in FIG. 1c, an application network element 105 is included. After the connection between the terminal device 103 and the first network element is established, the terminal device 103 receives application information of the application network element 105, the terminal device sends an access request to the application network element 105 based on the application information, and the application network element 105 is configured to receive the access request sent by the terminal device. For example, the application network element 105 is the first application network element in the first edge network. The connection establishment method provided in some embodiments further includes the following steps:

After the terminal device establishes a connection with the first control network element, the first control network element sends application information of the first application network element to the terminal device.

The terminal device receives the application information corresponding to the first application network element sent by the first control network element.

The terminal device sends an access request to the first application network element.

In some embodiments, the first edge network includes one or more application network elements, and each application network element sends application information of the application network element to the first control network element in the first edge network. The terminal device establishes a connection with the first control network element in the first edge network. For example, the terminal device establishes a connection with the first control network element, and the first control network element obtains the application information corresponding to the first application network element in the first edge network. The application information includes an application function supported by the first application network element. For example, the application information includes information about whether the first application network element supports migration, and load of the first application network element. For another example, the terminal device establishes a connection with the first control network element, and the central control network element obtains the application information corresponding to the first application network element in the first edge network. The application information includes an application function supported by the first application network element.

The terminal device receives the application information sent by the first control network element in the first edge network, the terminal device parses the application information to determine the first application network element included in the first edge network to which the terminal device establishes a connection, and the terminal device initiates an access request to the first application network element. In this way, the terminal device completes an entire process of application discovery.

In some embodiments, the core network element sends the first information to the control network element, where the first information indicates that the edge network corresponding to the user plane network element serving the terminal device changes. The control network element determines, based on the first information, that the edge network corresponding to the user plane network element serving the terminal device changes. The control network element sends the connection information of the first network element to the terminal device. The first network element is a network element in the first edge network corresponding to the user plane network element. The terminal device obtains, from the control network element, the connection information of the first network element, and establish a connection between the terminal device and the first network element. The edge network does not need to be preconfigured for the terminal device provided in some embodiments. The terminal device establishes the connection between the terminal device and the first network element based on the connection information of the first network element sent by the control network element. In this case, connection establishment is dynamically triggered based on a change of the edge network corresponding to the user plane network element, and a success rate of establishing a connection by the terminal device with the edge network is improved.

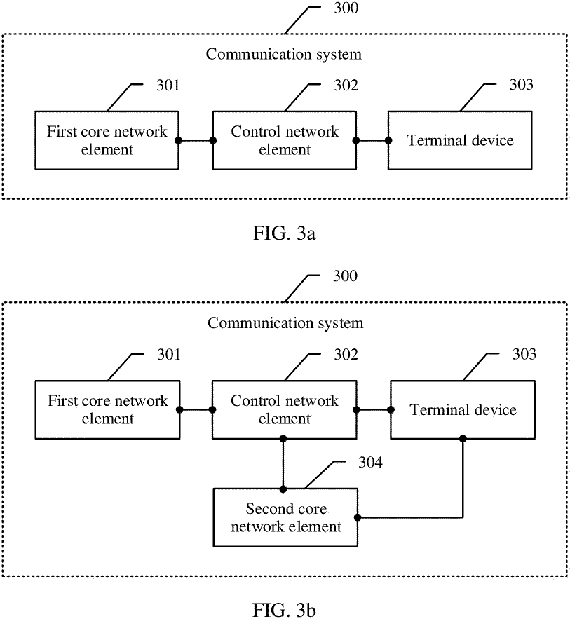

FIG. 3a is a schematic structural composition diagram of a communication system according to some embodiments. The communication system 300 provided in some embodiments includes a first core network element 301, a control network element 302, and a terminal device 303.

The first core network element 301 is configured to send first information to the control network element 302, where the first information indicates a location of the terminal device 303.

The first information is UE location information, one or more DNAIs corresponding to a UPF serving the UE, or the like.

In an embodiment, before the control network element receives the first information from the first core network element, the control network element sends location request information to the first core network element. The location request information requests the first core network element to send the location of the terminal device. For example, before the first core network element 301 sends the first information to the control network element 302, the control network element 302 sends the location request information to the first core network element 301 to request the location of the terminal device 303. Correspondingly, the first core network element 301 replies to the control network element 302 with the first information. The first information includes the UE location information.

In another embodiment, the control network element sends subscription request information to the first core network element, where the subscription request information requests the first core network element to send the first information in response to detecting that the location of the terminal device changes, the subscription request information requests the first core network element to send the first information in response to detecting that an edge network corresponding to a user plane network element changes, or the subscription request information requests the core network element to send the first information in response to detecting that a user plane management event occurs. For example, before the first core network element 301 sends the first information to the control network element 302, the control network element 302 sends the subscription request information to the first core network element 301, to subscribe to a DNAI change corresponding to the terminal device 303 or subscribe to a user plane path change of a session of the terminal device 303, and then sends the first information in response to the change occurring. Correspondingly, in response to the first core network element 301 detecting the DNAI change corresponding to the terminal device 303 or the user plane path change of the session, the first core network element 301 replies to the control network element 302 with the first information. The first information includes one or more DNAIs corresponding to the UPF serving the UE. The first information is included in a notification message.

The control network element 302 is configured to: receive the first information from the first core network element 301, and send connection information of a first network element to the terminal device 303 based on the first information, where the first network element is a network element in a first edge network corresponding to the user plane network element serving the terminal device, and the connection information is used for the terminal device to connect to the first network element.

The connection information of the first network element includes connection information of a first control network element and/or a first application network element in the first edge network corresponding to the user plane network element serving the terminal device 303, and the connection information is used for the terminal device 303 to connect to the first network element in the first edge network. A manner in which the control network element 302 determines one or more edge networks based on the first information is not limited. In an embodiment, service range information corresponding to the edge network is configured in the control network element 302, where the service range information is location information or a DNAI. In response to a service range of an edge network including the first information, the control network element 302 determines that the edge network is the first edge network available for the terminal device 303, and sends the connection information of the first network element in the first edge network to the terminal device 303.

The terminal device 303 is configured to: receive, from the control network element 302, the connection information of the first network element, and establish a connection between the terminal device and the first network element based on the connection information of the first network element.

The first core network element 301 communicates with the control network element 302. For example, the first core network element 301 directly communicates with the control network element 302, or indirectly communicates with the control network element 302 by using another network element in the communication system. Details are not limited herein. For example, the first core network element 301 is specifically a network element that implements a network capability exposure (network exposure function, NEF), or is an SMF. For example, the SMF directly or indirectly sends a notification message (where the notification message includes the first information, and the first information is one or more DNAIs) to the control network element 302 by using the NEF. Alternatively, the first core network element 301 is an AMF. The AMF directly or indirectly sends the UE location information to the control network element 302 by using the NEF.

The control network element 302 separately communicates with the first core network element 301 and the terminal device 303. For example, the control network element 302 directly communicates with the first core network element 301, or indirectly communicates with the first core network element 301 by using another network element in the communication system. Details are not limited herein. For another example, the control network element 302 directly communicates with the terminal device 303, or indirectly communicates with the terminal device 303 by using another network element in the communication system. Details are not limited herein. The control network element 302 is specifically a central control network element (further referred to as a central control network element). For example, the control network element 302 is an ECS or an AF. For example, the AF includes one or more of an EES, the ECS, and an EAS. The central control network element interacts with an AF in a local data center. An embodiment of the control network element 302 is determined with reference to an application scenario. Details are not limited herein.

A function of the terminal device 303 is similar to that of the terminal device 103 in the foregoing embodiment. Details are not described herein again.

In some embodiments, as shown in FIG. 3b, an embodiment provides a communication system 300, and the communication system 300 further includes a second core network element 304.

The control network element 302 sends the connection information to the terminal device based on the first information by using the second core network element 304.

For example, the control network element sends the connection information of the first network element to the second core network element 304. Alternatively, after receiving the connection information of the first network element sent by the control network element, the first core network element sends the connection information of the first network element to the second core network element 304, and the second core network element 304 sends the connection information of the first network element to the terminal device 303.

Specifically, communication between the control network element 302 and the terminal device 303 is completed by using the second core network element 304. For example, the second core network element 304 is specifically an SMF network element, a PCF network element, or an AMF network element. Details are not limited herein.

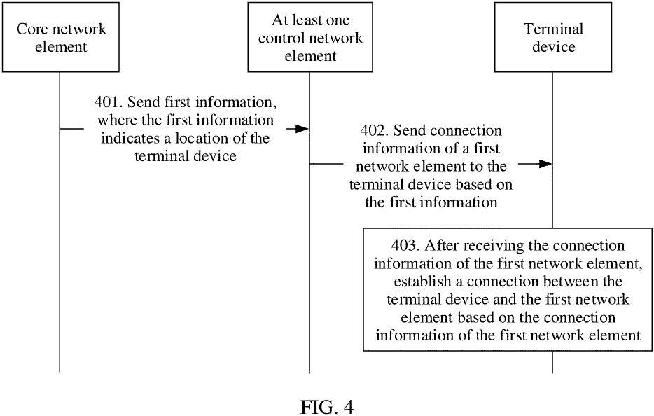

The foregoing embodiment describes the communication system. The following describes a communication method performed based on the communication system. Referring to FIG. 4, a connection establishment method provided in an embodiment of some embodiments mainly includes the following steps.

401. A first core network element sends first information to a control network element, where the first information indicates a location of a terminal device.

The first core network element provides the location of the terminal device for the control network element. For example, the first core network element actively sends the first information to the control network element, where the first information indicates the location of the terminal device. The first information is represented in a plurality of manners. The first information includes a DNAI identifier that indicates an identifier of a path between an edge network and a user plane network element serving the terminal, or include a list of candidate and available DNAIs adjacent to the terminal, where the list of DNAIs indicates the control network element to determine an appropriate edge network or determine information about an appropriate control network element. Alternatively, the first information is UE location information, for example, a TAI or a Cell ID.

In some embodiments, before step 401 in which the control network element receives the first information from the first core network element, the method provided in some embodiments further includes the following step:

The control network element sends location request information to the first core network element, where the location request information requests the first core network element to send the first information.

The control network element sends the location request information to the first core network element in response to a call for the location of the terminal device. The first core network element sends the first information to the control network element based on the location request information. The first information indicates the location of the terminal device. In some embodiments, the control network element obtains the location of the terminal device based on a call of the control network element. For the control network element, this manner improves flexibility of obtaining the location of the terminal device.

402. The control network element receives the first information from the first core network element, and sends connection information of a first network element to the terminal device based on the first information.

In some embodiments, the control network element receives the first information, and determines the location of the terminal device based on the first information. The control network element obtains the connection information of the first network element based on the location of the terminal device, and sends the connection information of the first network element to the terminal device based on the first information. The connection information of the first network element includes an address of the first network element, a unique identifier of the first network element, or the like. The control network element determines, based on the first information, the connection information of the first network element sent to the terminal device. In an embodiment, a user plane path between each user plane network element (for example, a UPF) and an edge network has a unique DNAI identifier. After receiving one or more DNAI identifiers, the control network element determines that an edge network corresponding to the DNAI identifier is an edge network currently most suitable for serving the UE, that is, determine that an edge network corresponding to the DNAI identifier is a first network. The first network element is a network element in the edge network corresponding to the DNAI identifier. The control network element sends the connection information of the first network element to the terminal device. In another embodiment, service range information of the edge network is configured on the control network element. In response to the first information including the location of the terminal device, the control network element determines that an edge network whose service range information includes the location of the terminal device is the first edge network, and the first network element is a network element in the first edge network. In another embodiment, service range information of a network element in the edge network is configured on the control network element. In response to the first information including the location of the terminal device, the control network element determines that a network element whose service range includes the location of the terminal device is the first network element.

403. The terminal device receives, from the control network element, the connection information of the first network element, and establishes a connection between the terminal device and the first network element based on the connection information of the first network element.

In some embodiments, the terminal device communicates with the control network element, the terminal device receives, from the control network element, the connection information of the first network element, the terminal device obtains, by parsing the connection information of the first network element, the connection information of the first network element in the first edge network corresponding to the user plane network element serving the terminal device, the terminal device determines, based on the connection information of the first network element, the first network element to which a connection needs to be established, and the terminal device establishes the connection with the first network element. In this way, a process of establishing a connection between the terminal device and the edge network is completed. In some embodiments, the terminal device receives the connection information of the first network element, so that the terminal device no longer uses a preconfigured manner to establish the foregoing connection. In addition, the connection information of the first network element is generated based on the location of the terminal device, so that a success rate of establishing the connection between the terminal device and the edge network is improved.

In some embodiments, a plurality of edge networks correspond to the user plane network element.

After step 401 in which the control network element receives the first information from the first core network element, the method provided in some embodiments further includes the following step:

The control network element selects at least one edge network from the plurality of edge networks as the first edge network based on at least the location of the terminal device.

Alternatively, the control network element selects at least one network element from network elements included in the plurality of edge networks as the first network element based on at least the location of the terminal device.

The core network element sends the first information to the control network element, and the first information further includes the location of the terminal device. In this case, the control network element obtains the location of the terminal device by using the first information. For example, the location of the terminal device is a DNAI. The control network element determines the first edge network or determines the first network element based on at least the location of the terminal device. In other words, the control network element determines, based on the location of the terminal device, the first edge network in a plurality of edge networks corresponding to a plurality of user plane network elements serving the terminal device. Alternatively, the control network element determines, based on the location of the terminal device, the first network element in network elements in a plurality of edge networks. In some embodiments, the control network element first determines the first edge network based on the location of the terminal device, and then determine the first network element in the first edge network. Details are not limited. Alternatively, the control network element directly determines the first network element in the network elements in the plurality of edge networks. For example, in response to a plurality of edge networks corresponding to a plurality of UPFs serving the terminal device include a plurality of EESs, the control network element determines the first network element in the plurality of EESs.

The connection establishment method provided in some embodiments further includes the following steps:
After the terminal device establishes a connection with the first control network element, the first control network element sends application information of the first application network element to the terminal device.
The terminal device receives the application information corresponding to the first application network element sent by the first control network element.
The terminal device sends an access request to the first application network element.

In some embodiments, the first edge network includes one or more application network elements, and each application network element sends application information of the application network element to the first control network element in the first edge network. The terminal device establishes a connection with the first control network element in the first edge network. For example, the terminal device establishes a connection with the first control network element, and the first control network element obtains the application information corresponding to the first application network element in the first edge network. The application information includes an application function supported by the first application network element. For example, the application information includes information about whether the first application network element supports migration, and load of the first application network element.

The terminal device receives the application information sent by the first control network element in the first edge network, the terminal device parses the application information to determine the first application network element included in the first edge network to which the terminal device establishes a connection, and the terminal device initiates an access request to the first application network element. In this way, the terminal device completes an entire process of application discovery.

In some embodiments, the core network element sends the first information to the control network element, where the first information indicates the location of the terminal device, the control network element obtains the location of the terminal device, and the control network element sends the connection information of the first network element to the terminal device based on the location of the terminal device. The connection information of the first network element includes connection information of a control network element in the edge network corresponding to the user plane network element serving the terminal device. The terminal device obtains, from the connection information of the first network element, connection information of a control network element in at least one edge network, and establish the connection between the terminal device and the first network element based on the connection information. The edge network does not need to be preconfigured for the terminal device in some embodiments. The terminal device establishes the connection between the terminal device and the first network element based on the connection information that is of the first network element and that is determined by the control network element. In this case, connection establishment is dynamically triggered based on the location of the terminal device, and a success rate of establishing a connection between the terminal device and the edge network is improved.

To better understand and implement the foregoing solutions in embodiments, the following uses corresponding application scenarios as examples for description.

Based on the communication systems as shown in FIG. 1a to FIG. 1c, and FIG. 3a and FIG. 3b, the following describes different application scenarios of the communication systems by using examples. FIG. 5a and FIG. 5b show two application scenarios of the foregoing communication systems. In the following embodiment, an example in which an edge network is an EDN (or referred to as an EHE) is used for description. An embodiment of the edge network as a data center is similar to this example.

As shown in FIG. 5a, an edge data network (edge data network, EDN) is a local data center, and the EDN includes an edge enabler server (edge enabler server, EES) and a plurality of edge application servers (edge application servers, EASs). Each EDN has a service range. The EES is a control network element (for example, an MEP) or a management network element in an MEC node, and is responsible for managing, for example, performing registration and DNS resolution on, each EAS deployed in the EDN. In addition, the EES invokes a capability exposure function of a network (3gpp network).

An edge data network configuration server (edge data network configuration server, EDNCS) or an edge configuration server (edge configuration server, ECS) is a global management network element that maintains information of each EDN such as a service range and an EES address. In some standard protocols such as technical specifications (technical specification, TS) 23.501 and TS 23.502, the foregoing EES, EAS, ECS, MEP, and the like are referred to as AFs. Details are not described below again.

The UE includes an edge enabler client (edge enabler client, EEC) and an application client (application client). The EEC provides support for the application client on the terminal. Functions of the EEC include: retrieving EDN information by using EDGE-4, enabling the UE to register with the EES, retrieving an available EAS, changing EAS availability, and notifying the EEC of EAS migration.

Specifically, in FIG. 5a, EDGE-1 indicates that the UE obtains an available application (EAS) in the EDN, EDGE-2 indicates network capability exposure invoking, EDGE-3 indicates that the EAS registers with the EES, EDGE-4 indicates that information about an available EDN is provided for the UE based on a location of the UE and an EDN service range, EDGE-6 indicates that the EDN registers with the EDNCS, EDGE-7 indicates that the EAS communicates with the 3GPP network, and EDGE-8 indicates that the EDNCS (ECS for short) communicates with the network.

As shown in FIG. 5b, at a location, the UE have a plurality of available EDNs, for example, EDN 1 and EDN 2 in FIG. 5b, used for accessing. In some embodiments, each EDN is accessed by using a local anchor UPF, for example, an L-PSA (local PDU session anchor) in FIG. 5b, and a central network is accessed by using a central local anchor UPF. A PSA in FIG. 5b is specifically a central (central) PSA. A ULCL and the L-PSA are co-deployed.

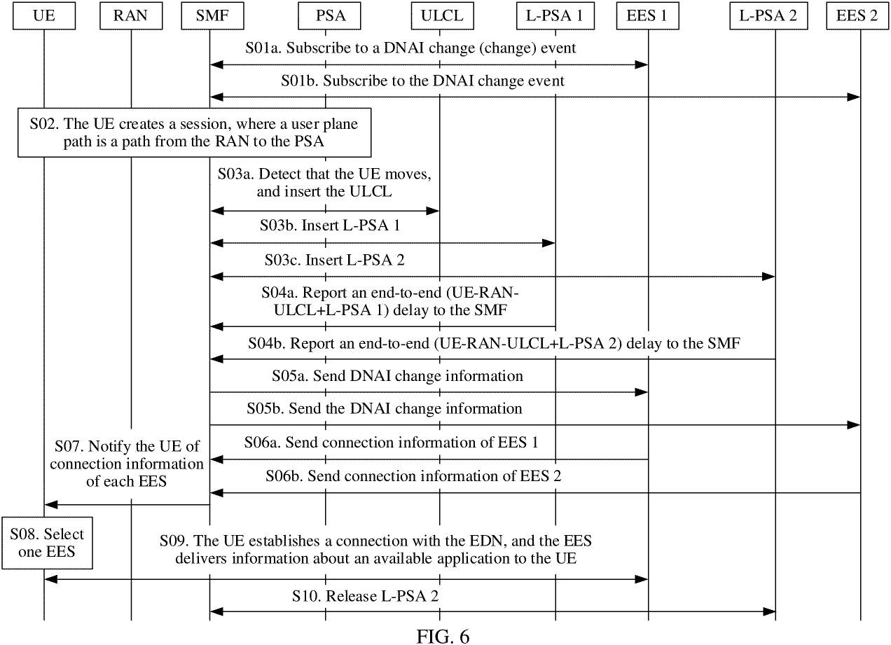

FIG. 6 is a schematic flowchart of interaction between a plurality of network elements in a communication system according to some embodiments. In a scenario described in this embodiment, each EHE or EDN subscribes to a DNAI change event from an adjacent network. After the UE creates a session, the UE moves and enter a service range of one or more EDNs. An SMF inserts a ULCL and an L-PSA. The SMF indicates the event to each adjacent EHE or EDN that subscribes to the DNAI change event. Each EHE or EDN sends its own EHE information or EDN information to the SMF. Subsequently, the SMF notifies the UE of the EHE information or the EDN information. An example in which a control network element included in each edge network is an EES, a core network element is an SMF, a user plane network element is an L-PSA, and a terminal device is UE is used for description. A procedure includes the following steps.

S01a. EES 1 subscribes to a DNAI change (change) event or a user plane management (user plane management) event from the SMF.

S01b. EES 2 subscribes to the DNAI change event or the user plane management (user plane management) event from the SMF.

A control network element of the EHE or the EDN is an EES, and the EES is further referred to as an AF (application function). For example, AF 1 and AF 2 separately subscribe to the DNAI change event from the SMF. The AF directly subscribes to the event from the SMF, or subscribes to the event from the SMF via a PCF and an NEF.

S02. The UE creates a session, where a user plane path includes a path from a RAN to a protocol data unit session anchor (PDU session anchor, PSA). The PSA is a central anchor of the session, and is far away from a location of the UE.

How the UE creates the session, and how the UE selects the PSA and creates a tunnel between the RAN and the PSA are not described again, where the user plane path includes UE-RAN-PSA.

S03a. The SMF detects that the UE moves, and inserts a ULCL.

The SMF detects that the UE moves, and selects a ULCL and inserts the ULCL, including establishing an N3 tunnel between the ULCL and the RAN and an N9 tunnel between the ULCL and the PSA.

S03b. The SMF inserts L-PSA 1.

S03c. The SMF inserts L-PSA 2.

The SMF selects an adjacent L-PSA, and establishes an N9 tunnel between the ULCL and the L-PSA. The ULCL and the L-PSA are co-deployed.

S04a. L-PSA 1 measures an end-to-end delay between the UE and L-PSA 1, and reports the delay to the SMF.

S04b. L-PSA 2 measures an end-to-end delay between the UE and L-PSA 2, and reports the delay to the SMF.

Specifically, an L-PSA on each candidate path measures an end-to-end delay, and reports the delay to the SMF. A delay measurement process is not described in detail.

S05a. The SMF sends DNAI change information or a user plane management message to EES 1.

S05b. The SMF sends the DNAI change information or the user plane management message to EES 2.

The SMF sends a DNAI change notification or the user plane management message to an AF corresponding to each adjacent L-PSA. Optionally, the notification message includes a DNAI identifier corresponding to the L-PSA or location information of the UE.

S06a. EES 1 sends EDN1 information to the SMF, where the EDN1 information includes connection information of EES 1 and/or connection information of an EAS.

S06b. EES 2 sends EDN2 information to the SMF, where the EDN2 information includes connection information of EES 2 and/or the connection information of the EAS.

Specifically, the AF includes EHE information (for example, an MEP address) or EDN information (for example, EES address information or EAS (list) information such as EAS address information in the EDN) in a reply message. The EHE information or the EDN information is used for the UE to establish a connection with the EES or the EAS. For example, the EHE information or the EDN information is an IP address, an FQDN, or a URI/URL of the EES or the EAS. Optionally, the EHE information or the EDN information further carries indication information, and the indication information indicates the SMF to send the EHE information or the EDN information to the UE. Optionally, the EHE information or the EDN information further includes N6 routing information (routing information), and the routing information indicates the L-PSA to offload a subsequent data packet to a corresponding EDN.

S07. The SMF notifies the UE of each piece of EDN information. For example, the EDN1 information includes the connection information of EES 1 and/or the connection information of the EAS, and the EDN2 information includes the connection information of EES 2 and/or the connection information of the EAS.

The SMF sends the EHE information or the EDN information and a delay of a corresponding path to the UE. The SMF sends the EHE information or the EDN information to the UE based on a local configuration or based on the indication information in step S06. Optionally, the SMF sends a delay of a path corresponding to each EHE or EDN to the UE.

S08. The UE selects one EES or EAS to establish a connection.

In response to the UE receiving a plurality of pieces of EHE information or EDN information, the UE selects one EHE or EDN based on a configuration or a policy, for example, selects an EHE or EDN corresponding to a minimum delay.

S09. The UE establishes a connection with the EDN.

In an embodiment, the UE establishes a connection with the EES, and the EES delivers information about an available EAS to the UE. The UE establishes a connection with the MEP or the EES based on the EHE information or the EDN information, and the AF delivers information about an available application (for example, information about whether the application supports migration, and load of the application) to the UE.

In an embodiment, in response to the UE receiving address information of the EAS, the UE directly establishes a connection with the EAS.

S10. The SMF releases L-PSA 2 corresponding to an EHE or an EDN that has not been accessed.

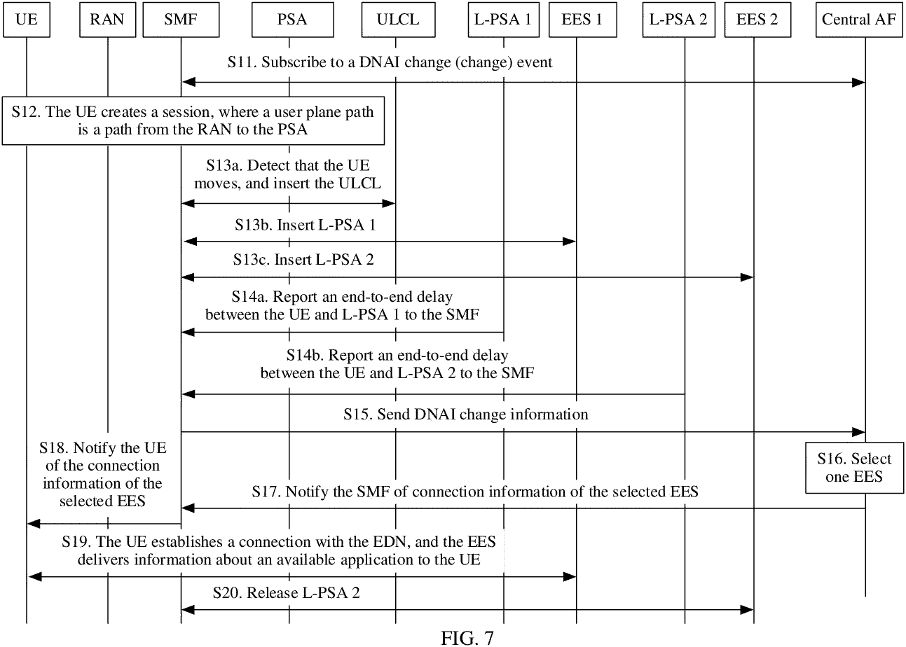

FIG. 7 is a schematic flowchart of interaction between a plurality of network elements in a communication system according to some embodiments. A difference between a scenario in this embodiment and the scenario in the foregoing embodiment lies in that there is a central AF, which is a network element in a control plane or a management plane. Specifically, the central AF is an ECS. The central AF, instead of each AF, subscribes to a DNAI change or a user plane management event from an SMF. In response to the event being detected, the SMF notifies the central AF of the event. In addition, in response to there being a plurality of EDNs available at the same time, the central AF decides to send information about one or more EDNs to the UE. However, in the foregoing embodiment, the information about the one or more EDNs is sent to the UE, and the UE makes a decision. The embodiment shown in FIG. 7 mainly includes the following procedure.

S11. The central AF subscribes to the DNAI change (change) event or the user plane management event from the SMF.

The central (central) AF subscribes to the DNAI change event or the user plane management event (user plane management event) from a network. The central (central) AF is further replaced with an ECS. This is not limited. That the AF subscribes to the event includes: The central AF directly subscribes to the event from a network element (for example, the SMF), or the AF subscribes to the event from the SMF via an NEF.

S12. The UE creates a session, where a user plane path includes a path from a RAN to a PSA.

S13a. The SMF detects that the UE moves, and inserts a ULCL.

S13b. The SMF inserts L-PSA 1.

S13c. The SMF inserts L-PSA 2.

S14a. L-PSA 1 measures an end-to-end delay between the UE and L-PSA 1, and reports the delay to the SMF.

S14b. L-PSA 2 measures an end-to-end delay between the UE and L-PSA 2, and reports the delay to the SMF.

S15. The SMF sends DNAI change information to the central AF.

For example, the SMF detects that the user plane management event occurs and notifies the central AF of the event. Optionally, the DNAI change information includes an end-to-end delay of each candidate path. Optionally, the DNAI change information further includes location information of the UE, or a DNAI identifier or a DNAI identifier list corresponding to the L-PSA.

S16. The central AF selects connection information of one or more edge networks (EHEs or EDNs), or selects connection information of network elements (EESs or EASs) in the one or more edge networks (EHEs or EDNs). Optionally, the ECS sends connection information of configured EDNs to the UE. Optionally, the ECS determines the one or more edge networks based on the received location information, the ECS determines one or more EESs based on the received location information, or the ECS determines one or more EASs based on the received location information. Optionally, the ECS sends connection information of configured EDNs to the UE.

In an embodiment, a user plane path between each UPF and an edge network has a unique DNAI identifier. In response to a notification message including one or more DNAI identifiers, the ECS determines that an edge network corresponding to the DNAI identifier is an edge network currently most suitable for serving the UE, that is, determine that an edge network corresponding to the DNAI identifier is a first network. A first network element is a network element in the edge network corresponding to the DNAI identifier. In another embodiment, service range information of the edge network is configured on the ECS. In response to the notification message including a location of the terminal device, the ECS determines that an edge network whose service range information includes the location of the terminal device is the edge network currently most suitable for serving the UE, that is, a first edge network. The first network element is a network element in the first edge network. In another embodiment, service range information of a network element in the edge network, for example, service range information of the EES and/or service range information of the EAS, is configured on the ECS. In response to the notification message including a location of the terminal device, the ECS determines that a network element whose service range includes the location of the terminal device is the first network element. Optionally, after the ECS determines the first network, the ECS determines the first network element. Assuming that the first network, namely, the EDN, includes a plurality of network elements, for example, one EES and a plurality of EASs, the first network element is a plurality of network elements, or is a subset of the plurality of network elements.

The connection information of the edge network (EHE or EDN) includes but is not limited to: EES address information, and EAS (list) information and EAS address information in the EDN. The address information is used for the UE to establish a connection with the EES or the EAS, and is an IP address, an FQDN, a URI, a URL, an EAS identifier, or the like. The edge network information is further understood as the connection information of the first network element in the foregoing embodiments.

The central AF (for example, the ECS) determines the one or more edge networks (EHEs or EDNs) based on a pre-configuration or an edge network selection policy, or in other manners. A manner is not limited. In an embodiment, one or more EHEs or EDNs corresponding to a minimum delay are selected, one or more EHEs or EDNs with minimum current load are selected, and so on. In another embodiment, the central AF has service range information of each EHE or EDN. In response to the DNAI change information in S15 including the location information of the UE or the DNAI identifier corresponding to the L-PSA, in response to service area information of an EDN including the location information of the UE or the DNAI identifier corresponding to the L-PSA, the central AF determines that the edge network is a selected edge network, so that the UE establishes a connection with the edge network.

S17. The central AF notifies the SMF of information about the selected edge network. For example, the information about the edge network includes connection information of a selected EES.

S18. The SMF notifies the UE of the information about the selected edge network. For example, the information about the edge network includes the connection information of the selected EES.

S19. The UE establishes a connection with the EDN.

In an embodiment, the UE establishes a connection with the EES, and the EES delivers information about an available EAS to the UE. The UE establishes a connection with the MEP or the EES based on the EHE information or the EDN information, and the AF delivers information about an available application (for example, information about whether the application supports migration, and load of the application) to the UE. Optionally, a request sent by the UE to the EES carries identification information of the EAS or an FQDN of the EAS, and the EES delivers corresponding address information to the UE.

In an embodiment, in response to the UE receiving address information of the EAS, the UE directly establishes a connection with the EAS.

S20. The SMF releases L-PSA 2.

In some embodiments, the central AF subscribes to the DNAI change event or the user plane management event from a 5G network, to perceive a change in an access location of the UE. In response to receiving the DNAI change or the user plane management event, the EHE pushes information about a selected edge network to the SMF, and then the SMF notifies the UE of the information about the edge network. Optionally, the SMF obtains end-to-end delay information from the L-PSA, and sends the delay information to the UE or the central AF. The UE or the AF determines an optimal EHE. The UE initiates a connection with the edge network. The UE obtains information about an available application from the EHE. In some embodiments, the central AF dynamically delivers information about an available EDN based on the location of the UE, and the UPF and the SMF do not need to configure an application (App) deployed in the EDN. In this case, coupling is reduced.

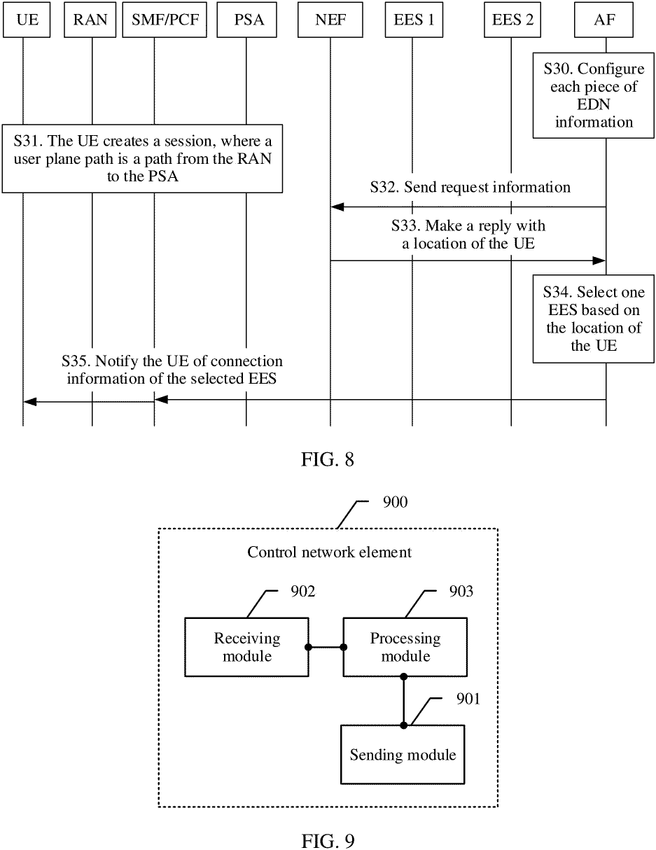

FIG. 8 is a schematic flowchart of interaction between a plurality of network elements in a communication system according to some embodiments. The following procedure is mainly included.

S30. An AF (for example, an ECS) configures each piece of EDN information or EHE information, where the EDN information or the EHE information includes but is not limited to one or more of the following information: a service range and load of an EDN, corresponding EES information and EAS information, and the like.

S31. UE creates a session, where a user plane path is a path from a RAN to a PSA.

S32. The AF sends request information or subscription request information. For example, the request information is the location request information in the foregoing embodiments.

In an embodiment, the AF sends a request message to an NEF to request a location of the UE.

In another embodiment, the AF sends the subscription request information to the NEF, to subscribe to a DNAI change corresponding to the UE or subscribe to a user plane management event of the session of the UE. Optionally, the DNAI change corresponding to the UE or the user plane management event of the session of the UE is detected by an SMF, and the NEF further invokes a service of the SMF. In some embodiments, in response to the AF directly communicating with the SMF, the AF sends the subscription request information to the SMF to subscribe to the DNAI change corresponding to the UE or subscribe to the user plane management event of the session of the UE. This is not shown in FIG. 8.

S33. The NEF replies to the AF with the location of the UE.

In an embodiment, the NEF sends the location information of the UE to the AF.

Step S33, in some embodiments, is replaced with the following step: In another embodiment, in response to the SMF or the NEF detecting a DNAI change corresponding to the UE or a user plane path change of the session, the SMF or the NEF sends notification information to the AF. Optionally, the notification message includes one or more DNAI identifiers corresponding to a UPF serving the UE.

S34. Based on a received message, the AF determines information about one or more edge networks, or selects connection information of a network element (EES or EAS) in the one or more edge networks (EHEs or EDNs). For a determining manner, refer to the descriptions of S16. Details are not described again.

The information about the edge network (EHE or EDN) includes but is not limited to: EES address information, and EAS (list) information such as EAS address information in the EDN. The address information is used for the UE to establish a connection with the EES or EAS, and is an IP address, an FQDN, a URI, a URL, or the like.

The AF (for example, the ECS) determines the one or more edge networks (EHEs or EDNs) based on a configuration or a policy, or in other manners. A manner is not limited. In an embodiment, one or more EHEs or EDNs corresponding to a minimum delay are selected, one or more EHEs or EDNs with minimum current load are selected, and so on. In another embodiment, the AF has service range information of each EHE or EDN. In response to the DNAI change information in S15 including the location information of the UE or the DNAI identifier corresponding to the L-PSA, in response to service area information of an EDN including the location information of the UE or the DNAI identifier corresponding to the L-PSA, the AF determines that the edge network is a selected edge network, so that the UE establishes a connection with the edge network.

S35. The AF notifies the UE of information about the determined edge network. For example, the information about the edge network includes connection information of a selected EES.

In an embodiment, the AF notifies the UE of the information about the edge network through an interface (for example, EDGE-4) between the AF and the UE. In another embodiment, the AF first sends the information about the edge network to a core network element, for example, the SMF, the NEF, an AMF, or a PCF, and then the core network element sends the information about the edge network to the UE. In response to the information being sent to the UE via the core network element, the information, in some embodiments, passes through a plurality of core network elements. A path is not limited. For example, the AF sends the information to the NEF, the NEF sends the information to the SMF, the SMF sends the information to the AMF, and the AMF sends the information to the UE. Alternatively, the AF sends the information to the SMF, the SMF sends the information to the AMF, and the AMF sends the information to the UE.

In some embodiments, for brief description, the foregoing method embodiments are represented as a series of actions. However, a person skilled in the art appreciates that the embodiments is not limited to the described order of the actions, because according to the embodiments, some steps is performed in other orders or simultaneously. Further appreciation by a person skilled in the art that embodiments described in this specification belong to example embodiments, and the involved actions and modules are not called for by the embodiments.

To better implement the solutions of embodiments, a related apparatus for implementing the solutions is further provided below.

Referring to FIG. 9, a control network element 900 provided in an embodiment of some embodiments includes a sending module 901, a receiving module 902, and a processing module 903.

The processing module is configured to receive first information from a core network element by using the receiving module, where the first information indicates that an edge network corresponding to a user plane network element serving a terminal device changes.

The processing module is configured to send connection information of a first network element to the terminal device based on the first information by using the sending module, where the first network element is a network element in a first edge network corresponding to the user plane network element, and the connection information is used for the terminal device to connect to the first network element.

In some embodiments, the processing module is configured to send subscription request information to the core network element by using the sending module, where the subscription request information requests the core network element to send the first information in response to detecting that a location of the terminal device changes, the subscription request information requests the core network element to send the first information in response to detecting that the edge network corresponding to the user plane network element changes, or the subscription request information requests the core network element to send the first information in response to detecting that a user plane management event occurs.

In some embodiments, the first information further includes the location of the terminal device; and the processing module is configured to: determine the first edge network or determine the first network element based on at least the location of the terminal device.

In some embodiments, the control network element is a central control network element, and a plurality of edge networks correspond to the user plane network element;
the processing module is configured to: select at least one edge network from the plurality of edge networks as the first edge network, or select at least one network element from network elements included in the plurality of edge networks as the first network element; and
the processing module is configured to send the connection information to the terminal device by using the sending module.

In some embodiments, the processing module is configured to receive a plurality of pieces of delay information from the core network element by using the receiving module, where each piece of delay information includes a transmission delay between the terminal device and one user plane network element; and the processing module is configured to: select at least one edge network from the plurality of edge networks as the first edge network based on at least the plurality of pieces of delay information; or select at least one network element from network elements included in the plurality of edge networks as the first network element based on at least the plurality of pieces of delay information.

In some embodiments, the control network element is a central control network element, one edge network corresponds to the user plane network element, and the one edge network corresponding to the user plane network element is the first edge network;
the processing module is configured to select at least one network element from network elements in the first edge network as the first network element; and
the processing module is configured to send the connection information to the terminal device by using the sending module.

In some embodiments, the processing module is configured to send the connection information to the terminal device by using the sending module and the core network element.

In some embodiments, the first network element includes at least one of the following: a first control network element in the first edge network and a first application network element in the first edge network.

In some embodiments, the processing module is configured to: after the terminal device establishes a connection with the first control network element, send application information of the first application network element to the terminal device by using the sending module.

In some embodiments, the core network element sends the first information to the control network element, where the first information indicates that the edge network corresponding to the user plane network element serving the terminal device changes. The control network element determines, based on the first information, that the edge network corresponding to the user plane network element serving the terminal device changes. The control network element sends the connection information of the first network element to the terminal device. The first network element is a network element in the first edge network corresponding to the user plane network element. The terminal device obtains, from the control network element, the connection information of the first network element, and establish a connection between the terminal device and the first network element. The edge network does not need to be preconfigured for the terminal device provided in some embodiments. The terminal device establishes the connection between the terminal device and the first network element based on the connection information of the first network element sent by the control network element. In this case, connection establishment is dynamically triggered based on a change of the edge network corresponding to the user plane network element, and a success rate of establishing a connection by the terminal device with the edge network is improved.

Referring to FIG. 9, another control network element 900 provided in an embodiment of some embodiments includes a sending module 901, a receiving module 902, and a processing module 903.

The processing module is configured to receive first information from a first core network element by using the receiving module, where the first information indicates a location of a terminal device.

The processing module is configured to send connection information of a first network element to the terminal device based on the first information by using the sending module, where the first network element is a network element in a first edge network corresponding to a user plane network element serving the terminal device, and the connection information is used for the terminal device to connect to the first network element.

In some embodiments, the processing module is configured to send location request information to the first core network element by using the sending module, where the location request information requests the first core network element to send the first information; or the processing module is configured to send subscription request information to the first core network element by using the sending module, where the subscription request information requests the first core network element to send the first information in response to detecting that the location of the terminal device changes, the subscription request information requests the first core network element to send the first information in response to detecting that the edge network corresponding to the user plane network element changes, or the subscription request information requests the core network element to send the first information in response to detecting that a user plane management event occurs.

In some embodiments, a plurality of edge networks correspond to the user plane network element; and
the processing module is configured to select at least one edge network from the plurality of edge networks as the first edge network based on at least the location of the terminal device; or
the processing module is configured to select at least one network element from network elements included in the plurality of edge networks as the first network element based on at least the location of the terminal device.

In some embodiments, the processing module is configured to send the connection information to the terminal device based on the first information by using the sending module and a second core network element.

In some embodiments, the first network element includes at least one of the following: a first control network element in the first edge network and a first application network element in the first edge network.

In some embodiments, the processing module is configured to: after the terminal device establishes a connection with the first control network element, send application information of the first application network element to the terminal device by using the sending module.

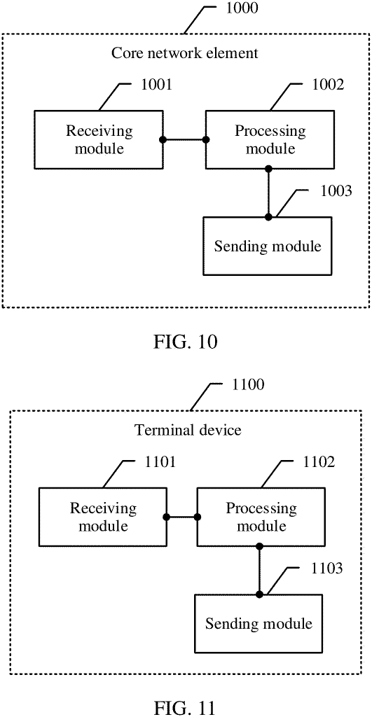

Referring to FIG. 10, a core network element 1000 provided in an embodiment of some embodiments includes a receiving module 1001, a processing module 1002, and a sending module 1003.

The processing module is configured to send first information to at least one control network element by using the sending module, where the first information indicates that an edge network corresponding to a user plane network element serving a terminal device changes.

The processing module is configured to receive, by using the receiving module, connection information of a first network element sent by the at least one control network element, where the first network element is a network element in a first edge network corresponding to the user plane network element, and the connection information is used for the terminal device to connect to the first network element.

The processing module is configured to send the connection information of the first network element to the terminal device by using the sending module.

In some embodiments, the processing module is configured to receive, by using the receiving module, location request information sent by the at least one control network element, where the location request information requests the core network element to send the first information; or the processing module is configured to receive, by using the receiving module, subscription request information sent by the control network element, where the subscription request information requests the core network element to send the first information in response to detecting that a location of the terminal device changes, or the subscription request information requests the core network element to send the first information in response to detecting that the edge network corresponding to the user plane network element changes.

In some embodiments, the first information further includes the location of the terminal device; and the location of the terminal device is used for the at least one control network element to determine the first edge network or determine the first network element.

In some embodiments, the at least one control network element includes a central control network element, and
a plurality of edge networks correspond to the user plane network element; and
the first edge network is at least one edge network selected by the central control network element from the plurality of edge networks; or
the first network element is at least one network element selected by the central control network element from network elements included in the plurality of edge networks.

In some embodiments, the processing module is configured to receive delay information from a plurality of user plane network element by using the receiving module, where each piece of delay information includes a transmission delay between the terminal device and one user plane network element; and the processing module is configured to send, to the central control network element by using the sending module, the delay information from the plurality of user plane network elements, where the delay information is used for the central control network element to: select at least one edge network from the plurality of edge networks as the first edge network, or select at least one network element from network elements included in the plurality of edge networks as the first network element.

In some embodiments, the processing module is configured to receive, by using the receiving module, indication information sent by the at least one control network element, where the indication information indicates the core network element to send the connection information to the terminal device.

In some embodiments, the core network element sends the first information to the control network element, where the first information indicates that the edge network corresponding to the user plane network element serving the terminal device changes. The control network element determines, based on the first information, that the edge network corresponding to the user plane network element serving the terminal device changes. The control network element sends the connection information of the first network element to the terminal device. The first network element is a network element in the first edge network corresponding to the user plane network element. The terminal device obtains, from the control network element, the connection information of the first network element, and establish a connection between the terminal device and the first network element. The edge network does not need to be preconfigured for the terminal device provided in some embodiments. The terminal device establishes the connection between the terminal device and the first network element based on the connection information of the first network element sent by the control network element. In this case, connection establishment is dynamically triggered based on a change of the edge network corresponding to the user plane network element, and a success rate of establishing a connection by the terminal device with the edge network is improved.

Referring to FIG. 11, a terminal device 1100 provided in an embodiment of some embodiments includes a receiving module 1101, a processing module 1102, and a sending module 1103.

The processing module is configured to receive, from a control network element by using the receiving module, connection information of a first network element, where the first network element is a network element in a first edge network corresponding to a user plane network element serving the terminal device.

The processing module is configured to establish a connection between the terminal device and the first network element based on the connection information.

In some embodiments, a plurality of edge networks correspond to the user plane network element; and
the processing module is configured to: select at least one edge network from the plurality of edge networks as the first edge network, or select at least one network element from network elements included in the plurality of edge networks as the first network element; and
the terminal device establishes a connection between the terminal device and the first network element based on the connection information.

In some embodiments, the processing module is configured to receive, by using the receiving module, delay information of a plurality of user plane network elements sent by the core network element, where each piece of delay information includes a transmission delay between the terminal device and one user plane network element; and the processing module is configured to: select at least one edge network from the plurality of edge networks as the first edge network based on at least the delay information; or select at least one network element from network elements included in the plurality of edge networks as the first network element based on at least the delay information.

In some embodiments, the first network element includes at least one of the following: a first control network element in the first edge network and a first application network element in the first edge network.

In some embodiments, the processing module is configured to: after the terminal device establishes a connection with the first control network element, receive, by using the receiving module, application information that corresponds to the first application network element and that is sent by the first control network element; and the processing module is configured to send an access request to the first application network element by using the sending module.

In some embodiments, the core network element sends the first information to the control network element, where the first information indicates that the edge network corresponding to the user plane network element serving the terminal device changes. The control network element determines, based on the first information, that the edge network corresponding to the user plane network element serving the terminal device changes. The control network element sends the connection information of the first network element to the terminal device. The first network element is a network element in the first edge network corresponding to the user plane network element. The terminal device obtains, from the control network element, the connection information of the first network element, and establish a connection between the terminal device and the first network element. The edge network does not need to be preconfigured for the terminal device provided in some embodiments. The terminal device establishes the connection between the terminal device and the first network element based on the connection information of the first network element sent by the control network element. In this case, connection establishment is dynamically triggered based on a change of the edge network corresponding to the user plane network element, and a success rate of establishing a connection by the terminal device with the edge network is improved.

Content such as information exchange between the modules/units of the apparatuses and the execution processes thereof is based on the same idea as the method embodiments, and produces the same technical effects as the method embodiments. For content, refer to the foregoing descriptions in the method embodiments. Details are not described herein again.

An embodiment further provides a computer storage medium. The computer storage medium stores a program. The program is executed to perform some or all of the steps recorded in the method embodiment.

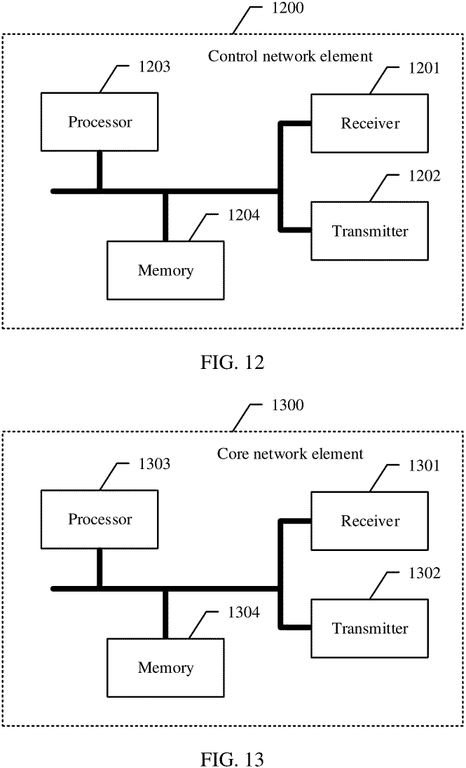

The following describes another control network element provided in an embodiment of some embodiments. Referring to FIG. 12, the control network element 1200 includes: a receiver 1201, a transmitter 1202, a processor 1203, and a memory 1204 (where there is one or more processors 1203 in the control network element 1200, and one processor is used as an example in FIG. 12). In some embodiments, the receiver 1201, the transmitter 1202, the processor 1203, and the memory 1204 are connected through a bus or in another manner. In FIG. 12, connection through a bus is used as an example.

The memory 1204 includes a read-only memory and a random access memory, and provide instructions and data to the processor 1203. A part of the memory 1204 further includes a non-volatile random access memory (non-volatile random access memory, NVRAM). The memory 1204 stores an operating system and operation instructions, an executable module or a data structure, or a subset thereof, or an extended set thereof. The operation instructions includes various operation instructions used to implement various operations. The operating system includes various system programs, to implement various services and process a hardware-based task.

The processor 1203 controls an operation of the control network element, and the processor 1203 is further referred to as a central processing unit (central processing unit, CPU). In an application, components of the control network element are coupled together through a bus system. In addition to including a data bus, the bus system further includes a power bus, a control bus, a status signal bus, and the like. However, for clear description, various types of buses in the figure are marked as the bus system.

The methods disclosed in the embodiments are applied to the processor 1203, or is implemented by using the processor 1203. The processor 1203 is an integrated circuit chip and has a signal processing capability. In an embodiment process, steps in the foregoing methods is implemented by using a hardware integrated logical circuit in the processor 1203, or by using instructions in a form of software. The processor 1203 is a general-purpose processor, a digital signal processor (digital signal processor, DSP), an application-specific integrated circuit (application-specific integrated circuit, ASIC), a field-programmable gate array (field-programmable gate array, FPGA) or another programmable logic device, a discrete gate or a transistor logic device, or a discrete hardware component. The processor 1203 implements or perform the methods, the steps, and logical block diagrams that are disclosed in embodiments. The general-purpose processor is a microprocessor, or the processor is any conventional processor or the like. Steps of the methods disclosed with reference to embodiments are directly executed and accomplished by using a hardware decoding processor, or are executed and accomplished by using a combination of hardware and software modules in the decoding processor. A software module is located in a mature storage medium in the art, such as a random access memory, a flash memory, a read-only memory, a programmable read-only memory, an electrically erasable programmable memory, or a register. The storage medium is located in the memory 1204, and the processor 1203 reads information in the memory 1204 and completes the steps in the foregoing methods in combination with hardware of the processor 1203.

The receiver 1201 is configured to: receive input digital or character information, and generate a signal input related to a related setting and function control of the control network element. The transmitter 1202 includes a display device such as a display screen, and the transmitter 1202 is configured to output digital or character information by using an external interface.

In some embodiments, the processor 1203 is configured to perform the connection establishment method performed by the foregoing control network element.

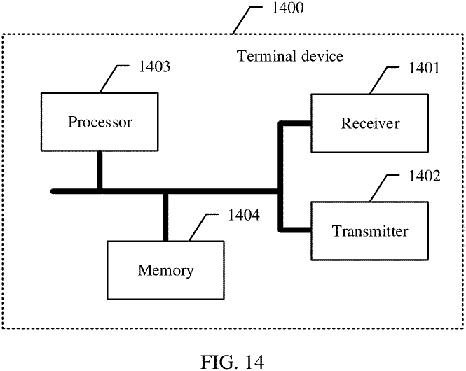

The following describes another core network element provided in an embodiment of some embodiments. Referring to FIG. 13, the core network element 1300 includes: a receiver 1301, a transmitter 1302, a processor 1303, and a memory 1304 (where there is one or more processors 1303 in the core network element 1300, and one processor is used as an example in FIG. 13). In some embodiments, the receiver 1301, the transmitter 1302, the processor 1303, and the memory 1304 are connected through a bus or in another manner. In FIG. 13, connection through a bus is used as an example.

The memory 1304 includes a read-only memory and a random access memory, and provide instructions and data for the processor 1303. A part of the memory 1304 further includes an NVRAM. The memory 1304 stores an operating system and operation instructions, an executable module or a data structure, or a subset thereof, or an extended set thereof. The operation instructions includes various operation instructions used to implement various operations. The operating system includes various system programs, to implement various services and process a hardware-based task.

The processor 1303 controls an operation of the core network element, and the processor 1303 is further referred to as a CPU. In an application, components of the core network element are coupled together through a bus system. In addition to including a data bus, the bus system further includes a power bus, a control bus, a status signal bus, and the like. However, for clear description, various types of buses in the figure are marked as the bus system.

The methods disclosed in the embodiments are applied to the processor 1303, or is implemented by using the processor 1303. The processor 1303 is an integrated circuit chip, and has a signal processing capability. In an embodiment process, steps in the foregoing methods is implemented by using a hardware integrated logical circuit in the processor 1303, or by using instructions in a form of software. The foregoing processor 1303 is a general-purpose processor, a DSP, an ASIC, an FPGA or another programmable logic device, a discrete gate or transistor logic device, or a discrete hardware component. The foregoing processor 1303 is implemented or performs the methods, the steps, and logical block diagrams that are disclosed in embodiments. The general-purpose processor is a microprocessor, or the processor is any conventional processor or the like. Steps of the methods disclosed with reference to embodiments are directly executed and accomplished by using a hardware decoding processor, or are executed and accomplished by using a combination of hardware and software modules in the decoding processor. A software module is located in a mature storage medium in the art, such as a random access memory, a flash memory, a read-only memory, a programmable read-only memory, an electrically erasable programmable memory, or a register. The storage medium is located in the memory 1304, and the processor 1303 reads information in the memory 1304 and completes the steps in the foregoing methods in combination with hardware in the processor 1303.

In some embodiments, the processor 1303 is configured to perform the connection establishment method performed by the core network element.

The following describes another terminal device provided in an embodiment of some embodiments. Referring to FIG. 14, the terminal device 1400 includes: a receiver 1401, a transmitter 1402, a processor 1403, and a memory 1404 (where there is one or more processors 1403 in the terminal device 1400, and one processor is used as an example in FIG. 14). In some embodiments, the receiver 1401, the transmitter 1402, the processor 1403, and the memory 1404 are connected through a bus or in another manner. In FIG. 14, connection through a bus is used as an example.

The memory 1404 includes a read-only memory and a random access memory, and provide instructions and data for the processor 1403. A part of the memory 1404 further includes an NVRAM. The memory 1404 stores an operating system and operation instructions, an executable module or a data structure, or a subset thereof, or an extended set thereof. The operation instructions includes various operation instructions used to implement various operations. The operating system includes various system programs, to implement various services and process a hardware-based task.

The processor 1403 controls operations of the terminal device, and the processor 1403 is further referred to as a CPU. In an application, components of the terminal device are coupled together through a bus system. In addition to a data bus, the bus system further includes a power bus, a control bus, a status signal bus, and the like. However, for clear description, various types of buses in the figure are marked as the bus system.

The methods disclosed in the embodiments are applied to the processor 1403, or is implemented by using the processor 1403. The processor 1403 is an integrated circuit chip, and has a signal processing capability. In an embodiment process, steps in the foregoing methods is implemented by using a hardware integrated logical circuit in the processor 1403, or by using instructions in a form of software. The foregoing processor 1403 is a general-purpose processor, a DSP, an ASIC, an FPGA or another programmable logic device, a discrete gate or transistor logic device, or a discrete hardware component. The foregoing processor 1403 implements or performs the methods, the steps, and logical block diagrams that are disclosed in embodiments. The general-purpose processor is a microprocessor, or the processor is any conventional processor or the like. Steps of the methods disclosed with reference to embodiments are directly executed and accomplished by using a hardware decoding processor, or are executed and accomplished by using a combination of hardware and software modules in the decoding processor. A software module is located in a mature storage medium in the art, such as a random access memory, a flash memory, a read-only memory, a programmable read-only memory, an electrically erasable programmable memory, or a register. The storage medium is located in the memory 1404, and the processor 1403 reads information in the memory 1404 and completes the steps in the foregoing methods in combination with hardware in the processor 1403.

In some embodiments, the processor 1403 is configured to perform the connection establishment method performed by the terminal device.

In another embodiment, in response to the control network element, the core network element, and the terminal device being chips, the chips include a processing unit and a communication unit. The processing unit is, for example, a processor. The communication unit is, for example, an input/output interface, a pin, or a circuit. The processing unit executes computer-executable instructions stored in a storage unit, so that the chip in the terminal performs the report information sending method according to any one of some embodiments of the first aspect. Optionally, the storage unit is a storage unit in the chip, for example, a register or a cache. Alternatively, the storage unit is a storage unit that is in the terminal and that is located outside the chip, for example, a read-only memory (read-only memory, ROM), another type of static storage device that stores static information and instructions, or a random access memory (random access memory, RAM).

The processor mentioned anywhere above is a general-purpose central processing unit, a microprocessor, an ASIC, or one or more integrated circuits configured to control program execution of the methods.

In addition, the described apparatus embodiment is an example. The units described as separate parts are or are not be physically separate, and parts displayed as units are or are not physical units, is located in one position, or is distributed on a plurality of network units. Some or all the modules are selected according to actual needs to achieve the objectives of the solutions of embodiments. In addition, in the accompanying drawings of the apparatus embodiments , connection relationships between modules indicate that the modules have communication connections with each other, which is specifically implemented as one or more communication buses or signal cables.

Based on the description of the foregoing implementations, a person skilled in the art clearly understands that the embodiments is implemented by software in addition to universal hardware, or by dedicated hardware, including a dedicated integrated circuit, a dedicated CPU, a dedicated memory, a dedicated component, and the like. Generally, any functions that is performed by a computer program is further implementable by using corresponding hardware. Moreover, a hardware structure used to achieve a same function is in various forms, for example, in a form of an analog circuit, a digital circuit, or a dedicated circuit. However, as for the embodiments, software program implementation is a better implementation in most cases. Based on such an understanding, the technical solutions in the embodiments essentially or the part contributing to the prior art is implemented in a form of a software product. The computer software product is stored in a readable storage medium, such as a floppy disk, a USB flash drive, a removable hard disk, a ROM, a RAM, a magnetic disk, or an optical disc of a computer, and includes several instructions for instructing a computer device (which is a personal computer, a server, a network device, or the like) to perform the method in embodiments.

All or some of the foregoing embodiments is implemented by using software, hardware, firmware, or any combination thereof. In response to software being used to implement the embodiments, all or a part of the embodiments is implemented in a form of a computer program product.

The computer program product includes one or more computer instructions. In response to the computer program instructions being loaded and executed on the computer, the procedure or functions according to embodiments are all or partially generated. The computer is a general-purpose computer, a dedicated computer, a computer network, or other programmable apparatuses. The computer instructions are stored in a computer-readable storage medium or are transmitted from a computer-readable storage medium to another computer-readable storage medium. For example, the computer instructions are transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium is any usable medium accessible by a computer, or a data storage device, such as a server or a data center, integrating one or more usable media. The usable medium is a magnetic medium (for example, a floppy disk, a hard disk, or a magnetic tape), an optical medium (for example, a DVD), a semiconductor medium (for example, a solid-state drive (Solid-State Drive, SSD)), or the like.

1. A connection establishment method, comprising:
receiving, by a control network element, first information from a core network element, wherein the first information is used to indicate that an edge network serving a terminal device changes; and
sending, by the control network element, connection information of a first network element to the terminal device based on the first information, wherein the first network element is a network element in the edge network serving the terminal device, and the connection information is used by the terminal device to connect to the first network element.

2. The method according to claim 1, wherein:
before the receiving, by the control network element, the first information from the core network element, the method further comprising
sending, by the control network element, subscription request information to the core network element, wherein:
the subscription request information is used to request the core network element to send the first information in response to detecting that a location of the terminal device changes;
the subscription request information is used to request the core network element to send the first information in response to detecting that the edge network serving the terminal device changes; or
the subscription request information is used to request the core network element to send the first information in response to detecting that a user plane management event occurs.

3. The method according to claim 1, wherein:
the first information further comprises a data network access identifier (DNAI), corresponding to the edge network serving the terminal device; and
the method further comprising
determining, by the control network element, the edge network serving the terminal device or determining the first network element based on at least the DNAI.

4. The method according to claim 2, further comprising:
obtaining, by the control network element, the location of the terminal device from the core network element; and
determining, by the control network element, the edge network serving the terminal device or determining the first network element based on at least the location of the terminal device.

5. The method according to claim 4 , wherein:
the determining, by the control network element, the edge network serving the terminal device or determining the first network element based on at least the location of the terminal device comprises:
determining, by the control network element, a network element whose service range includes the location of the terminal device as the first network element or
determining, by the control network element, another edge network whose service range includes the location of the terminal device as the edge network serving the terminal device.

6. The method according to claim 1, wherein:
the control network element is a central control network element, and a plurality of edge networks serve the terminal device; and
wherein the sending, by the control network element, the connection information of the first network element to the terminal device based on the first information comprises:
selecting, by the central control network element, at least one edge network from the plurality of edge networks as the edge network serving the terminal device; or
selecting, by the central control network element, at least one network element from network elements included in the plurality of edge networks as the first network element; and
sending, by the central control network element, the connection information to the terminal device.

7. The method according to claim 6, further comprising
receiving, by the central control network element, a plurality of pieces of delay information from the core network element, wherein each piece of delay information includes a transmission delay between the terminal device and one user plane network element;
the selecting, by the central control network element, the at least one edge network from the plurality of edge networks as the edge network serving the terminal device comprises:
selecting, by the central control network element based on at least the plurality of pieces of delay information, the at least one edge network from the plurality of edge networks as the edge network serving the terminal device; and
the selecting, by the central control network element, the at least one network element from the network elements included in the plurality of edge networks as the first network element comprises:
selecting, by the central control network element, the at least one network element from the network elements included in the plurality of edge networks as the first network element based on at least the plurality of pieces of delay information.

8. The method according to claim 1, wherein:
the control network element is a central control network element, and one edge network serves the terminal device; and
the sending, by the control network element, the connection information of the first network element to the terminal device based on the first information comprises:
selecting, by the central control network element, at least one network element from network elements in the edge network serving the terminal device as the first network element; and
sending, by the central control network element, the connection information to the terminal device.

9. The method according to claim 1, wherein:
the control network element is a control plane application network element, and a plurality of edge networks serve the terminal device; and
the sending, by the control network element, the connection information of the first network element to the terminal device based on the first information comprises:
selecting, by the control plane application network element, at least one edge network from the plurality of edge networks as the edge network serving the terminal device; or
selecting, by the control plane application network element, at least one network element from network elements included in the plurality of edge networks as the first network element; and
sending, by the control plane application network element, the connection information to the terminal device.

10. The method according to claim 1, wherein:
the sending, by the control network element, the connection information of the first network element to the terminal device comprises:
sending, by the control network element, the connection information to the terminal device via the core network element.

11. The method according to claim 1, wherein:
the first network element includes at least one of the following:
a first control network element in the edge network serving the terminal device; or
a first application network element in the edge network serving the terminal device.

12. The method according to claim 11, further comprising
in response to the terminal device establishing a connection with the first control network element, sending, by the control network element, application information of the first application network element to the terminal device.

13. The method according to claim 4, wherein:
the location of the terminal device includes at least one of a tracking area identity TAI or a cell identifier Cell ID.

14. A connection establishment method, comprising:
sending, by a core network element, first information to at least one control network element, wherein the first information is used to indicate that an edge network serving a terminal device changes;
receiving, by the core network element, connection information of a first network element sent by the at least one control network element, wherein the first network element is a network element in the edge network serving the terminal device, and the connection information is used by the terminal device to connect to the first network element; and
sending, by the core network element, the connection information of the first network element to the terminal device.

15. The method according to claim 14, wherein:
before the sending, by the core network element, the first information to the at least one control network element, the method further comprising:
receiving, by the core network element, location request information sent by the at least one control network element, wherein the location request information requests the core network element to send the first information; or
receiving, by the core network element, subscription request information sent by the control network element, wherein the subscription request information requests the core network element to send the first information in response to detecting that a location of the terminal device changes, the subscription request information requests the core network element to send the first information in response to detecting that the edge network serving the terminal device changes, or the subscription request information requests the core network element to send the first information in response to detecting that a user plane management event occurs.

16. The method according to claim 14, wherein:
the first information further includes a data network access identifier (DNAI), corresponding to the edge network serving the terminal device; and
the DNAI is used by the at least one control network element to determine the edge network serving the terminal device or determine the first network element.

17. The method according to claim 14, wherein:
the at least one control network element includes a central control network element, and a plurality of edge network serve the terminal device; and
the edge network serving the terminal device is at least one edge network selected by the central control network element from a plurality of edge networks; or
the first network element is at least one network element selected by the central control network element from network elements included in the plurality of edge networks.

18. The method according to claim 17, further comprising:
receiving, by the core network element, delay information from a plurality of user plane network elements, wherein each piece of delay information includes a transmission delay between the terminal device and one user plane network element; and
sending, by the core network element to the central control network element, the delay information from the plurality of user plane network elements, wherein the delay information is used by the central control network element to:
select at least one edge network from the plurality of edge networks as the edge network serving the terminal device; or
select at least one network element from network elements included in the plurality of edge networks as the first network element.

19. A communication apparatus, comprises:
a processor; and
a memory, operably connected to the processor, storing instructions which, in response to being executed by the processor, cause the processor to:
receive first information from a core network element, wherein the first information is used to indicate that an edge network serving a terminal device changes; and
send connection information of a first network element to the terminal device based on the first information, wherein the first network element is a network element in the edge network serving the terminal device, and the connection information is used by the terminal device to connect to the first network element.

20. A communication apparatus, comprises:
a processor; and
a memory storing instructions which, in response to being executed by the processor, cause the processor to:
send first information to at least one control network element, wherein the first information is used to indicate that an edge network serving a terminal device changes;
receive connection information of a first network element sent by the at least one control network element, wherein the first network element is a network element in the edge network serving the terminal device, and the connection information is used by the terminal device to connect to the first network element; and
send the connection information of the first network element to the terminal device.
